(19) United States
(12) Patent Application Publication
(10) Pub. No.: US 2025/0083600 A1
(43) Pub. Date: Mar. 13, 2025

(54) METHOD FOR MOVING AT LEAST ONE REARVIEW DEVICE AND ACTUATOR

(71) Applicant: MOTHERSON INNOVATIONS COMPANY LIMITED, London (GB)

(72) Inventors: Levente KURTI, Portchester (GB); Marc MOORE, Portchester (GB)

(21) Appl. No.: 18/292,444

(22) PCT Filed: Jul. 26, 2022
(86) PCT No.: PCT/EP2022/070965

§ 371 Date: Jan. 26, 2024

(30) Foreign Application Priority Data
Jul. 30, 2021 (DE) 10 2021 119 913.1

(51) Int. Cl. B60R 1/072; F16H 1/22; F16H 37/04

(52) U.S. Cl. CPC B60R 1/072; F16H 1/222; F16H 37/042

(57) ABSTRACT

The inventions relates to a method for moving at least one rearview device of at least one rearview assembly around at least one first axis and around at least one second axis, by at least one actuator comprising at least one electrically driven first drive device and at least one electrically driven second drive device, wherein the method comprises controlling the first drive device and the second drive device such that only one of the drive devices is driven at a time as well as to an actuator for moving at least one rearview device around at least one first axis and around at least one second axis, the actuator comprising at least one electrically driven first drive device and at least one electrically driven second drive device wherein the actuator is configured to move the rearview device according to an inventive method.

### CROSS-REFERENCE TO RELATED APPLICATIONS

This application is a is a National Stage Entry of International Patent Application No. PCT/EP2022/070965, filed on Jul. 26, 2022, which claims the benefit of priority to German Patent Application No. DE 10 2021 119 913.1, filed on Jul. 30, 2021, each of which is hereby incorporated by reference in its entirety for all purposes.

### FIELD

The present disclosure relates to a method for moving at least one rearview device of at least one rearview assembly around at least one first axis and around at least one second axis, by at least one actuator comprising at least one electrically driven first drive device and at least one electrically driven second drive device and to an actuator for moving, in particular folding and/or adjustment, of at least one rearview device, in particular an actuator for moving at least one rearview device around at least one first axis and around at least one second axis, the actuator comprising at least one electrically driven first drive device and at least one electrically driven second drive device.

### BACKGROUND

The statements in this section merely provide background information related to the present disclosure and may not constitute prior art.

Vehicles are mandated by safety regulation to have a rearview system comprising at least on rearview assembly that is operable to provide a driver of the vehicle a rearward field of view. The rearview assembly typically includes one or more components that are required to be actuated relative to the vehicle body along a first axis, such components may include mirrors or cameras. As an example, the actuation of components along a first axis may provide the driver of the vehicle the ability to fine tune the rearward field of view provided by the rearview assembly.

Further, some rearview assemblies provide actuation of one or more components along a second axis, such components may include mirrors or cameras. As an example, the actuation of components along a secondary axis allows the components to be stored closer to the vehicle body in certain conditions. Generally, actuation of components in a rearview assembly along a secondary axis is achieved using a secondary actuator.

For example rearview assemblies comprise a mirror base and a mirror head, wherein within the mirror head a mirror plate mounted on a glass actuator is located. This glass actuator adjusts the mirror to move the mirror to the desired position. In addition the mirror head can be moved relative to the mirror base into a use position and into a stowed position.

The mirror plate moves within a bezel frame incorporated in the mirror head. Between the mirror plate and bezel is a gap to allow movement of the mirror plate, this gap leads to aerodynamic drag during driving. Gaps between the external mirror components also contribute to this drag.

It is thus desirable to have a frameless external rearview device that mounts the rearview device, like a mirror or a camera, on the front of the mirror housing and adjusts the complete rearview head to the desired position. By mounting the rearview device in a fixed position relative to the rearview head, there is no gap between the rearview device and the bezel. Therefore, drag is reduced improving airflow and fuel efficiency of the vehicle. The design also permits fewer components in the rearview head housing, reducing gaps in the external surface, further reducing drag.

On a frameless external rearview device, the two separate actuator approach of a glass actuator and powerfold used in conventional mirrors would not be suitable for a frameless mirror design due to the necessary ranges of movement of more than 20 annual degrees compared to about 8 annual degrees used in glass actuators. Although such ranges of movement in predefined time ranges can be reached by using additional gearboxes such gearboxes lead to noisy, heavy, and large in size actuators thereby making the actuators costlier. Furthermore such actuators do not provide sufficient torque to move the rearview head.

When using drive devices providing a sufficient movement velocity and sufficient torque have an increased power consumption. However the power supply provided for the actuator by the energy supply system of the vehicle. In a specific example the drive device has a power draw of 2 A, in particular in a stalling condition leading to a power consumption of a maximum of 4 A when actuating both drive devices, whereas the vehicle provides outputs for the powerfold actuator and the glass actuator, respectively of a maximum of 3 A.

This leads to the need of an improved method and improved actuator for moving such a rearview device.

### SUMMARY

To improve the method the present disclosure provides thus a method for moving at least one rearview device of at least one rearview assembly around at least one first axis and around at least one second axis, by at least one actuator comprising at least one electrically driven first drive device and at least one electrically driven second drive device, wherein the method comprises controlling the first drive device and the second drive device such that only one of the drive devices is driven at a time.

For the method it is proposed that the method comprises providing at least one circuitry connected at least indirectly to the first drive device and the second drive device for controlling the first drive device and the second drive device, wherein the circuitry is connectable to the actuator and/or the circuitry is at least partly comprised by the actuator.

It proposed that based on a first signal a power supply is switched between the first drive device and the second drive device and/or based on a second signal the polarity provided to the first drive device and the second drive device is switched.

In the before described embodiment it is preferred that the first signal is provided to a first input of the circuitry and the second signal is provided to a second input of the circuitry.

A method might be further characterized in that the first signal is provided by at least one first power source, wherein preferably the first signal, especially provided to the first input, is at least partly formed by the output of the first power source with a first polarity to switch the power supply to the first drive device and/or the first signal, especially provided to the first input, is at least partly formed by the output of the first power source with a second polarity being opposite to the first polarity to switch the power supply to the second drive device.

Also it is preferred that the second signal is provided by at least one second power source, wherein preferably the second signal, especially provided to the second input, is at least partly formed by the output of the second power source with a first polarity to run the first drive device in a first direction or the second drive device in a third direction and/or the second signal, especially provided to the second input, is at least partly formed by the output of the second power source with a second polarity being opposite to the first polarity to run the first drive device in a, in particular to the first direction opposite, second direction or to run the second drive device in a, in particular to the third direction opposite, fourth direction.

It is furthermore preferred that by the circuitry, in particular with the help of at least one first power source, a power supply is switched between the first drive device and the second drive device and/or by the circuitry the chosen drive device is provided with energy of at least one second power source to move the rearview device.

It is also proposed that the first power source provides the circuitry with a smaller maximum electrical output than the second power source.

Alternatively it is proposed that the second power source provides the circuitry with a smaller maximum electrical output than the first power source.

Advantageous embodiments of the method might be characterized in that in a first status of a first switch the first power source is coupled to a first subsection of the circuitry connected to the first drive device with a first polarity and to a second subsection of the circuitry connected to the second drive device with a second polarity and in a second status of the first switch the first power source is connected with the second polarity to the first subsection and with the first polarity to the second subsection.

Furthermore it is proposed in the before described embodiment that at least one electronic element, in particular at least one diode, located in the first subsection or the second subsection is driven in a blocking direction when the respective subsection is connected with the first polarity to the first power source and is driven in a pass direction when the respective subsection is connected with the second polarity to the first power source.

Furthermore the method might be characterized in that in a first status of a second switch the second power source is coupled to the first subsection connected to the first drive device with a first polarity and to the second subsection connected to the second drive device with a second polarity and in a second status of the second switch the second power source is coupled to the first subsection with the second polarity and to the second subsection with the first polarity.

It is preferred that (i) in the first status of the first switch and the first status of the second switch the first drive device is driven in a first direction and/or in the first status of the first switch and the second status of the second switch the first drive device is driven in a, preferably with respect to the first direction opposite, second direction, wherein especially the second drive is not driven in the first status of the first switch and/or (ii) in the second status of the first switch and the first status of the second switch the second drive device is driven in a third direction and/or in the second status of the first switch and the second status of the second switch the second drive device is driven in a, preferably with respect to the third direction opposite, fourth direction, wherein especially the first drive is not driven in the second status of the first switch.

Finally it is proposed for the method that the first direction of the first drive device corresponds to a movement of the rearview device around the first axis in a first direction, the second direction of the first drive device corresponds to a movement of the rearview device around the first axis in a second direction, the first direction of the second drive device corresponds to a movement of the rearview device around the second axis in a third direction and the fourth direction of the second drive device corresponds to a movement of the rearview device around the second axis in a fourth direction and/or the first axis corresponds to a tilt axis of the rearview device and/or the second axis corresponds to a fold axis of the rearview device.

Furthermore an improved circuitry connectable to at least one actuator for moving at least one rearview device around at least one first axis and around at least one second axis, is proposed wherein the actuator comprises at least one electrically driven first drive device and at least one electrically driven second drive device, and wherein the circuitry is configured to move the rearview device according to a method as described before and/or claimed with the enclosed claims.

It is proposed that the circuitry is connected at least indirectly to the first drive device and the second drive device for controlling the first drive device and the second drive device.

It is also proposed that the circuitry is connected at least indirectly, preferably via at least one vehicle module, like a door zone module, a control module, a vehicle bus module and/or a control area network bus module, to at least one first power source and/or at least one second power source.

It is preferred that the circuitry comprises at least one first input, wherein preferably at least one first signal can be provided to the first input, wherein especially by the first signal a power supply is switched between the first drive device and the second drive device, and/or the circuitry comprises at least one second input, wherein preferably at least one second signal can be provided to the second input, wherein especially by the second signal the polarity provided to the first drive device and/or the second drive device is switched.

Furthermore it is proposed that the first signal is provided by the first power source, wherein preferably the first signal is at least partly formed by the output of the first power source with a first polarity to switch the power supply to the first drive device and/or the first signal is at least partly formed by the output of the first power source with a second polarity being opposite to the first polarity to switch the power supply to the second drive device.

In the before described embodiments optionally the second signal is provided by at least one second power source, wherein preferably the second signal is at least partly formed by the output of the second power source with a first polarity to run the first drive device in a first direction or the second drive device in a third direction and/or the second signal is at least partly formed by the output of the second power source with a second polarity being opposite to the first polarity to run the first drive device in a, in particular to the first direction opposite, second direction or to run the second drive device in a, in particular to the third direction opposite, fourth direction.

The circuitry and/or the first drive device might comprises at least one first drive device driver to control at least one actuator or motor of the first drive device and/or the circuitry and/or of the second drive device comprises at least one second drive device driver to control at least one actuator or motor of the second drive device.

In the before described embodiments of the circuitry it is preferred that the circuitry comprises at least one first switch, preferably at least partly comprised by the vehicle module, to connect a first power supply to the first drive device and the second drive device.

Furthermore it is proposed that the circuitry comprises at least one first subsection connected to the first drive device and at least one second subsection connected to the second drive device, wherein in at least one first status of the first switch the first power source is coupled to the first subsection with a first polarity and to the second subsection with a second polarity and in at least one second status with the second polarity to the first subsection and with the first polarity to the second subsection.

The circuitry might be characterized in that the circuitry, in particular the first subsection and/or the second subsection, comprises at least one electronic element, in particular at least one diode, wherein the electronic element is driven in a blocking direction when the respective subsection is connected with the first polarity to the first power source and is driven in a pass direction when the respective subsection is connected with the second polarity to the first power source.

Also it is proposed that the circuitry comprises at least one second switch, wherein in a first status of the second switch the second power source is coupled to the first subsection with a first polarity and to the second subsection with a second polarity and in a second status of the second switch the second power source is coupled to the first subsection with the second polarity and to the second subsection with the first polarity.

In addition the circuitry might be characterized in that (i) in the first status of the first switch and the first status of the second switch the first drive device is driven in a first direction and/or in the first status of the first switch and the second status of the second switch the first drive device is driven in a, preferably with respect to the first direction opposite, second direction, wherein especially the second drive device is not driven in the first status of the first switch and/or (ii) in the second status of the first switch and the first status of the second switch the second drive device is driven in a third direction and/or in the second status of the first switch and the second status of the second switch the second drive device is driven in a, preferably with respect to the third direction opposite, fourth direction, wherein especially the first drive device is not driven in the second status of the first switch.

Furthermore an actuator for moving at least one rearview device around at least one first axis and around at least one second axis is proposed, wherein the actuator comprises at least one electrically driven first drive device and at least one electrically driven second drive device, wherein the actuator is connectable or connected to and/or at least partly comprises a circuitry according to one of the before described embodiments and/or the actuator is configured to move the rearview device according to a method of one of the before described embodiments

Additionally the actuator might have the additional features that the first axis and the second axis are running at angle to each other, in particular the first axis and the second axis are running perpendicular to each other.

Furthermore it is proposed that the first drive device and/or the second drive device comprise at least one DC motor.

It is also proposed that the actuator, in particular the circuitry, comprises at least one sensing device, preferably at least indirectly connected to the vehicle module, wherein by the sensing device at least one first parameter of the first drive device and/or at least one second parameter of the second drive device is determinable.

In the before described embodiment it is preferred that the first parameter and/or the second parameter comprises at least one position, at least one moving direction, at least one moving speed and/or at least one acceleration of the first drive device and/or the second drive device.

Additionally it is preferred that the actuator comprises at least one gear assembly having a secondary tilt gear and a secondary fold gear; wherein said secondary tilt gear comprises a first spur gear portion, a first worm gear portion, and a first transition point, wherein said first transition point divides said secondary tilt gear into said first spur gear portion and said first worm gear portion; wherein said first worm gear portion comprises a first end having a first diameter and a second end having a second diameter, wherein said first end is disposed adjacent to said first transition point of said secondary tilt gear and, wherein said second end is disposed opposite of said first end, and wherein said first diameter is larger than said second diameter; wherein said secondary fold gear comprises a second spur gear portion, a second worm gear portion, and a second transition point, wherein said second transition point divides said secondary fold gear into said second spur gear portion and said second worm gear portion; wherein said second worm gear portion comprises a third end having a third diameter and a fourth end having a fourth diameter, wherein said third end is disposed adjacent to said second transition point of said secondary fold gear and, wherein said fourth end is disposed opposite of said third end, and wherein said third diameter is larger than said fourth diameter; and wherein said second worm gear portion and said second spur gear portion are formed as a single element.

A further preferred embodiment might be characterized in that wherein said secondary fold gear comprises a cavity.

In the before described embodiments of the actuator it is preferred that the gear assembly further comprises a biasing element and a worm insert, wherein the biasing element is received into said cavity of said secondary fold gear such that said worm insert is movably received in said cavity and abutted against said biasing element.

Advantageous embodiments of the actuator might have the features that the actuator comprises at least one gear assembly having: a secondary tilt gear comprising an aperture; a secondary fold gear comprising an aperture and a cavity; a spindle having a first end and a second end; a biasing element; a worm insert; a slide having a channel; wherein said aperture of said secondary tilt gear receives said first end of said spindle; wherein said slide is attached to said spindle by fitting said channel onto said spindle, and wherein said slide is arranged adjacent to said secondary tilt gear; wherein said biasing element is arranged to be received inside of said cavity of said secondary fold gear; wherein said worm insert is arranged to be received inside of said cavity of said secondary fold gear; wherein said biasing element is received into said cavity of said secondary fold gear such that said worm insert is movably received in said cavity and abutted against said biasing element.; and wherein said aperture of said secondary fold gear receives said second end of said spindle.

For the before described embodiment it is proposed that said biasing element exerts a biasing force against said worm insert; and wherein said biasing force biases said slide towards said secondary tilt gear.

It is also preferred that said secondary tilt gear further comprises a first spur gear portion, a first worm gear portion, and a first transition point, wherein said first transition point divides said secondary tilt gear into said first spur gear portion and said first worm gear portion; wherein said first worm gear portion comprises a first end having a first diameter and a second end having a second diameter, wherein said first end is disposed adjacent to said first transition point of said secondary tilt gear and, wherein said second end is disposed opposite of said first end, and wherein said first diameter is larger than said second diameter; wherein said secondary fold gear further comprises a second spur gear portion, a second worm gear portion, and a second transition point, wherein said second transition point divides said secondary fold gear into said second spur gear portion and said second worm gear portion; wherein said second worm gear portion comprises a third end having a third diameter and a fourth end having a fourth diameter, wherein said third end is disposed adjacent to said second transition point of said secondary fold gear and, wherein said fourth end is disposed opposite of said third end, and wherein said third diameter is larger than said fourth diameter; and wherein said second worm gear portion and said second spur gear portion are formed as a single element.

An actuator according to one of the before described embodiments might be characterized in that the rearview assembly has a rearview head and a rearview base, wherein preferably the rearview head comprises at least one mirror device and/or at least one camera device and/or the rearview head is moved relative to the mirror base by the actuator.

It is furthermore preferred that a fold drive comprises the first drive device, wherein preferably the fold drive is operable to rotate said rearview head in the first direction about the first axis relative to said rearview base and rotate said rearview head in the second direction about said first axis; a tilt drive comprises the second drive device, wherein preferably the tilt drive is operable to rotate said rearview head in the third direction about the second axis relative to said rearview base and rotate said rearview head in the fourth direction about said second axis relative to said rearview base.

Additionally it is proposed that the rotation of said secondary fold gear in a first secondary fold gear direction results in said fold drive rotating said rearview head in said first direction about said first axis and wherein the rotation of said secondary fold gear in a second secondary fold gear direction results in said fold drive rotating said rearview head in said second direction about said first axis; and wherein the rotation of said secondary tilt gear in a first secondary tilt gear direction results in said tilt drive rotating said rearview head in said third direction about said second axis and wherein the rotation of said secondary tilt gear in a second secondary tilt gear direction results in said tilt drive rotating said rearview head in said fourth direction about said second axis.

The present disclosure furthermore describes that said secondary fold gear may rotate as said secondary tilt gear remains stationary.

A further embodiment might be characterized in that said secondary tilt gear may rotate as said secondary fold gear remains stationary.

It is also proposed that said secondary fold gear may rotate as said secondary tilt gear rotates.

An actuator according to one of the before described embodiments might be characterized in that said actuator comprises: a primary fold gear; and a secondary fold gear; said primary fold gear comprising a plurality of extensions extending radially inward from an inner circumference of said primary fold gear; and a first set of teeth; wherein a distance between each of said plurality of extensions is uniformly arranged around said inner circumference; and wherein said plurality of extensions further comprises a first taper; said secondary fold gear having a second set of teeth; and wherein said first set of teeth of said primary fold gear mesh with said second set of teeth of said secondary fold gear such that said first set of teeth and said second set of teeth have a first spacing.

For the before described embodiment it is preferred that said actuator further comprises: a gear seat arranged adjacent to said primary fold gear; wherein said gear seat has a second taper; and wherein said first taper of said primary fold gear contacts said second taper of said gear seat.

For this embodiment it is additionally proposed that a spring operable to apply a biasing force to said primary fold gear such that said primary fold gear is biased towards said gear seat; and wherein a deformation of the primary fold gear occurs when said primary fold gear is biased towards said gear seat.

It is also preferred that said deformation of said primary fold gear modifies the first spacing between said first set of teeth of said primary fold gear and said second set of teeth of said secondary fold gear to a second spacing; wherein said first spacing is different than said second spacing.

A preferred actuator might be characterized by a secondary tilt gear comprising a spur gear portion, a worm gear portion, and a transition point; wherein said transition point divides said secondary fold gear into said spur gear portion and said worm gear portion; and wherein said worm gear portion comprises a second set of teeth.

An actuator can further comprise: a gear assembly comprising a primary tilt gear, a spindle and a carrier arranged on said spindle wherein said carrier comprises a slot; wherein said primary tilt gear comprises a carrier connector receivable in said slot of said carrier; wherein said primary tilt gear may rotate in a first tilt direction or a second tilt direction; and wherein said carrier is slidable in a first translation direction along said spindle when the primary tilt gear rotates in said first tilt direction; and said carrier is slidable in a second translation distance along the spindle when said primary tilt gear rotates in said second tilt direction.

In the before described embodiment it is preferred that the actuator further comprises a wiper attached to said carrier.

In addition the actuator might be characterized by a PCB with an attached carbon strip wherein said wiper contacts said carbon strip.

For the before described embodiment it is preferred that said wiper is slidable along said carbon strip in a first wiper direction when said carrier slides in said first translation direction along said spindle; and wherein said wiper is slidable along said carbon strip in a second wiper direction when said carrier slides in said second translation direction along said spindle.

Finally it is proposed for the actuator that the rearview device, in particular the rearview head, is movable around the first axis and/or the second axis, in particular in the first direction, the second direction, the third direction and/or the fourth direction, by at least 20 angular degrees, preferably by at least 25 angular degrees, more preferably by at least 40 angular degrees, more preferably by at least 60 angular degrees, most preferably by at least 90 angular degrees.

Thus the claimed subject matter is based on the astonishing perception that an actuator for a rearview device of a review assembly can be controlled such that increased movement ranges can be provided that simultaneously allow a movement over the increased movement ranges within predefined time spans as well as provide the torques necessary for moving the complete rearview device, in particular a complete rearview head, without overloading a power supply system of the vehicle and without increasing the costs, weight or complexity of the actuator.

In particular the need to use costly high performance drive devices can be avoided. Such high performance drive devices have costs that are about two orders of magnitude higher as the costs for drive devices used in common glass actuators.

By ensuring that only one of the drive devices is actuated and is drawing electrical power the power provided by the power supply system for ordinary powerfold and glass actuators of common vehicles can be used to also actuate the two drive devices separately to move a complete rearview head in all four directions.

It should be noted that the features set out individually in the following description can be combined with each other in any technically advantageous manner and set out other forms of the present disclosure. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number. The description further characterizes and specifies the present disclosure in particular in connection with the figures.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a vehicle in accordance with aspects of the present disclosure;

FIG. 2A illustrates a top down view of rearview mirror assembly in accordance with aspects of the present disclosure;

FIG. 2B illustrates a top down view of rearview mirror assembly in accordance with aspects of the present disclosure;

FIG. 3A illustrates a side view of rearview mirror assembly in accordance with aspects of the present disclosure;

FIG. 3B illustrates a side view of rearview mirror assembly in accordance with aspects of the present disclosure;

FIG. 3C illustrates a side view of rearview mirror assembly in accordance with aspects of the present disclosure;

FIG. 4A illustrates a first embodiment of a circuitry usable to perform the claimed method and usable with and/or in a claimed actuator;

FIG. 4B illustrates schematically a second embodiment of a circuitry usable to perform the claimed method and usable with and/or in a claimed actuator;

FIG. 4C illustrates a realization of the circuitry of FIG. 4B;

FIG. 5 illustrates an actuator in accordance with aspects of the present disclosure;

FIG. 6 illustrates an actuator with its upper housing and lower housing removed in accordance with aspects of the present disclosure;

FIG. 7 illustrates a perspective view of a gear assembly in accordance with aspects of the present disclosure;

FIG. 8 illustrates an exploded view of a gear sub assembly in accordance with aspects of the present disclosure;

FIG. 9 illustrates a gear sub assembly fully assembled in accordance with aspects of the present disclosure;

FIG. 10 illustrates a tilt gear and fold gear in accordance with aspects of the present disclosure;

FIG. 11 illustrates a lower housing without a gear sub assembly installed in accordance with aspects of the present disclosure;

FIG. 12 illustrates a lower housing with a gear sub assembly installed in accordance with aspects of the present disclosure;

FIG. 13 illustrates the relative positions between a gear sub assembly and a fold drive in accordance with aspects of the present disclosure;

FIG. 14 illustrates the relative positions between a gear sub assembly and a tilt drive in accordance with aspects of the present disclosure;

FIG. 15 illustrates a perspective view of a gear assembly during operation in accordance with aspects of the present disclosure;

FIG. 16A illustrates an exploded view of the front of a tilt drive in accordance with aspects of the present disclosure;

FIG. 16B illustrates an exploded view of the back of a tilt drive in accordance with aspects of the present disclosure;

FIG. 17 illustrates the location of a tilt journal and attachment point of a tilt drive in accordance with aspects of the present disclosure;

FIG. 18 illustrates the arrangement of a tilt axle and tilt clutch in accordance with aspects of the present disclosure;

FIG. 19 illustrates the arrangement of a tilt axle, tilt clutch, and tilt inner in accordance with aspects of the present disclosure.

FIG. 20 illustrates a perspective view of a tilt drive fully assembled in accordance with aspects of the present disclosure;

FIG. 21 illustrates a bottom-up view of an upper housing in accordance with aspects of the present disclosure;

FIG. 22 illustrates a tilt drive assembled within an upper housing in accordance with aspects of the present disclosure;

FIG. 23 illustrates the arrangement of a gear assembly and tilt drive in their installed positions within an actuator in accordance with aspects of the present disclosure;

FIG. 24A illustrates the operation of a tilt clutch during manual operation in accordance with aspects of the present disclosure;

FIG. 24B illustrates the operation of a tilt clutch during manual operation in accordance with aspects of the present disclosure;

FIG. 25 illustrates a tilt clutch sliding along a tilt gear when manually disengaged in accordance with aspects of the present disclosure;

FIG. 26 illustrates a tilt memory system in accordance with aspects of the present disclosure;

FIG. 27 illustrates an alternative view of a tilt memory system in accordance with aspects of the present disclosure;

FIG. 28 illustrates an exploded top-down view of a fold drive in accordance with aspects of the present disclosure;

FIG. 29 illustrates a detailed view of a shaft, slip collar, lock ring, and fold spring in accordance with aspects of the present disclosure;

FIG. 30 illustrates the assembly of a fold drive within a lower housing in accordance with aspects of the present disclosure;

FIG. 31 illustrates a lower housing assembled with a fold drive in accordance with aspects of the present disclosure;

FIG. 32 illustrates a shaft, slip collar, lock ring, fold spring, and lower housing assembled in accordance with aspects of the present disclosure;

FIG. 33 illustrates a fold clutch in accordance with aspects of the present disclosure;

FIG. 34 illustrates a fold clutch installed in a fold drive in accordance with aspects of the present disclosure;

FIG. 35 illustrates a perspective view of a fold clutch, fold gear, gear seat, and retainer in accordance with aspects of the present disclosure;

FIG. 36 illustrates a fold drive fully assembled in accordance with aspects of the present disclosure.

FIG. 37 illustrates an alternative view of a fold drive assembled in accordance with aspects of the present disclosure;

FIG. 38 illustrates a top-down view of a fold gear in accordance with aspects of the present disclosure;

FIG. 39 illustrates a top-down view of a fold drive and gear sub assembly installed within a lower housing of an actuator in accordance with aspects of the present disclosure;

FIG. 40 illustrates a perspective view of a gear assembly and fold drive installed within a lower housing of an actuator in accordance with aspects of the present disclosure;

FIG. 41A illustrates a fold clutch engaged during manual operation of a fold drive in accordance with aspects of the present disclosure;

FIG. 41B illustrates a fold clutch disengaged during manual operation of a fold drive in accordance with aspects of the present disclosure;

FIG. 42 illustrates a fold memory wiper installed on a gear seat in accordance with aspects of the present disclosure; and

FIG. 43 illustrates the operation of a fold memory wiper in accordance with aspects of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

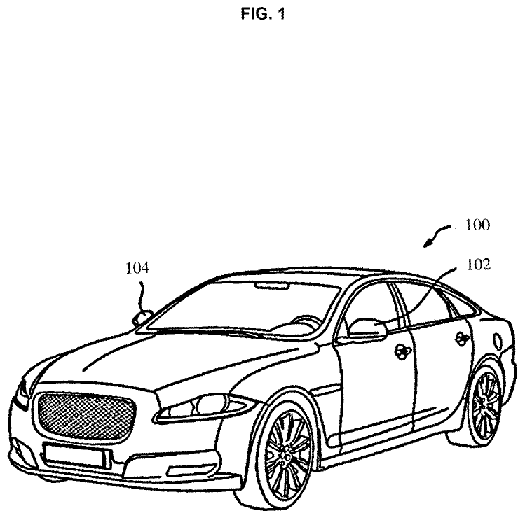

FIG. 1 illustrates a vehicle 100 in accordance with aspects of the present disclosure.

As shown in FIG. 1, vehicle 100 includes rearview assemblies in form of a rearview mirror assembly 102 and a rearview mirror assembly 104, respectively. Although vehicle 100 is illustrated as a passenger car, vehicle 100 may be any other type of vehicle, non-limiting examples of vehicle 100 include a truck, off-road vehicle, bus, motorcycle, aircraft, tram, locomotive, or heavy-duty vehicle.

In FIG. 1, rearview assembly 102 and rearview assembly 104 are illustrated as side view mirrors. In alternative variations, rearview assembly 102 and rearview assembly 104 may be implemented as camera systems. Rearview mirror assembly 102 and rearview mirror assembly 104 are arranged on vehicle 100 such that they may be adjusted to provide a view rearward of the vehicle to the driver.

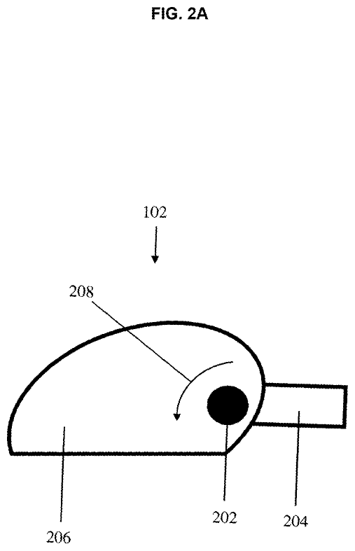

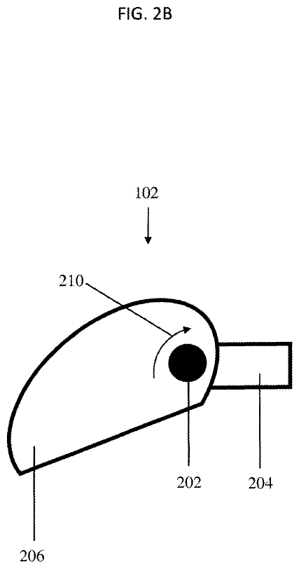

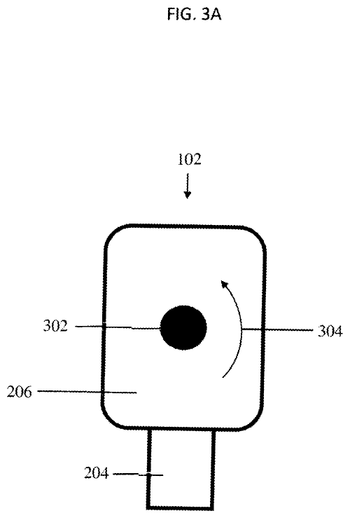

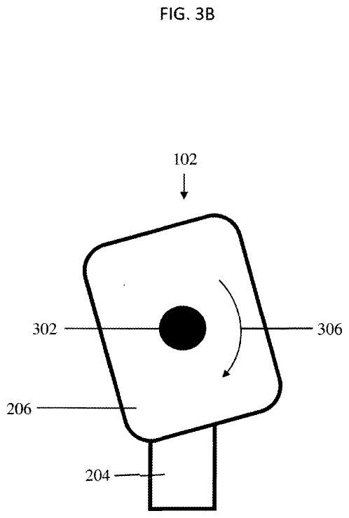

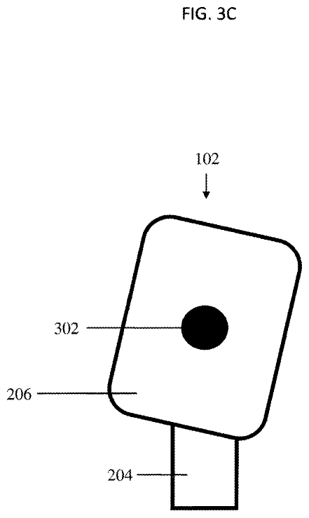

The operation of rearview mirror assembly 102 and rearview mirror assembly 104 will now be further described with additional reference to FIGS. 2A-3C.

FIG. 2A-B illustrates a top down view of rearview mirror assembly 102 in accordance with aspects of the present disclosure.

As shown in the figure, rearview assembly 102 includes an axis 202, a rearview base in form of a mirror base 204, and a rearview head in form of a rearview mirror head 206. In FIG. 2A, rearview mirror assembly 102 can be seen in a top down view with mirror head 206 in the drive position. When actuated in a first fold direction 208 relative to axis 202, movement is imparted to mirror head 206 to rotate it around axis 202 to a stored position as shown in FIG. 2B. Additionally, when actuated in second fold direction 210 relative to axis 202, movement can be imparted to mirror head 206 when in the stored position shown in FIG. 2B to rotate it back to the drive position shown in FIG. 2A.

The actuation of the mirror head about axis 202 can be done from any position to move the mirror head to any other position about axis 202. For example, the mirror head may start in the stored position as shown in FIG. 2B and then be actuated in the second direction about axis 202 to move the mirror head to the drive position. Mirror head 206 may be adjusted to any position between the drive position shown in FIG. 2A and the stored position shown in FIG. 2B.

Additionally, when mirror head 206 is in the drive position as shown in FIG. 2A, actuation can be performed such that it moves mirror head 206 to adjust the rearward field of view of the driver of the vehicle. Generally, the amount of movement adjusting mirror head 206 such that it adjusts the rearward field of view of the driver of the vehicle is less than the movement required to adjust mirror head 206 from the drive position to the stored position or from the stored position to the drive position.

FIG. 3A-C illustrates a side view of rearview mirror assembly 102 in accordance with aspects of the present disclosure.

As shown in the figure, rearview mirror assembly 102 includes a mirror base 204, a mirror head 206, and an axis 302. In FIG. 3A, rearview mirror assembly 102 can be seen in a side view with mirror head 206 in a nominal position. When actuated in first tilt direction 304, movement is imparted to mirror head 206 such that it is tilted upwards to the position shown in FIG. 3B. When actuated in second tilt direction 306, movement is imparted to mirror head 206 such that it is tilted downward to the position shown in FIG. 3C.

The actuation of the mirror head about axis 302 can be done from any position to move the mirror head to any other position about axis 302. For example, the mirror head may start in a tilted upwards position as shown in FIG. 3B and then actuated in the second direction to tilt the mirror head downwards. While being tilted downwards, actuation can be stopped to adjust the mirror head to the nominal position shown in FIG. 3A or continued to adjust the mirror head downwards until it reaches the position shown in FIG. 3C. Further, the mirror head can be tilted to any position between the positions shown in FIG. 3B and FIG. 3C. The description and the discussion of the figures that follows is in regards to rearview mirror assembly 102, however it should be noted that rearview mirror assembly 104 functions in a similar fashion.

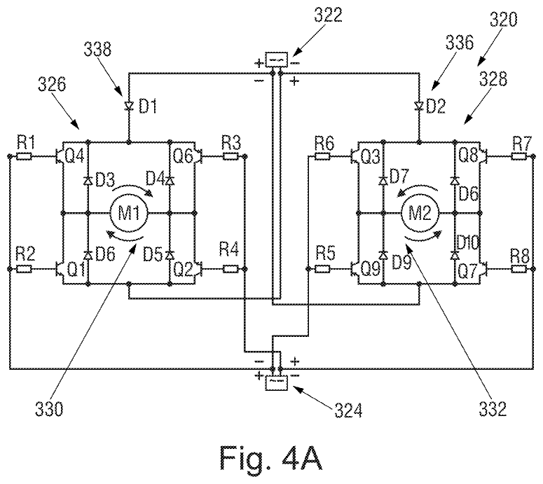

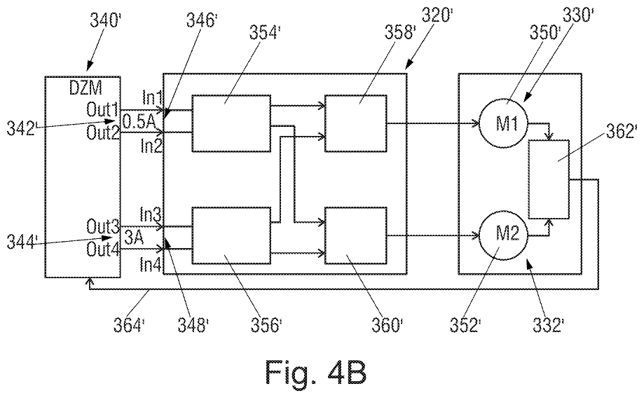

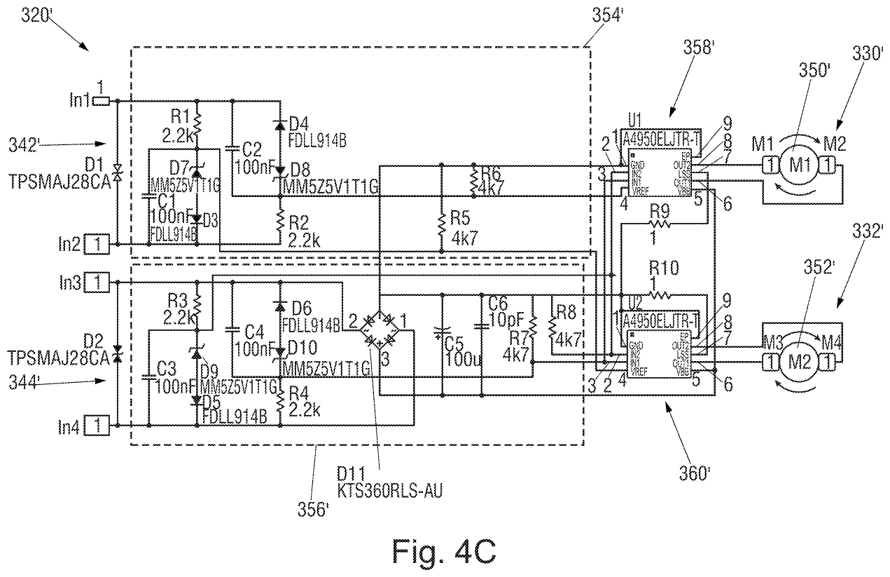

FIG. 4A illustrates a schematic of a circuitry 320 usable to implement the claimed method that can be connected to an actuator or can be comprised by such an actuator. The circuitry 320 comprises a first switch 322 being connected to a not shown first power source of the vehicle and a second switch 324 being connected to a not shown second power source of the vehicle. The circuitry 320 furthermore comprises a first subsection 326 and a second subsection 328. The first subsection 326 is connected to a first drive device 330 wherein the second subsection 328 is connected to a second drive device 332.

In the example the first power source provides the first switch 322 with a maximum current of 1 A whereas the second power source provides the second switch 324 with a maximum current of 3 A.

Depending on the status of the first switch 322 and the second switch 324 the first drive device 330 and the second drive device 332 are driven such that they are not driven simultaneously but only one of the drive devices 330, 332 is operated at a time.

In the example the first switch 322 provides the first subsection 326 with a first polarity, in the example a positive voltage, whereas the second 328 subsection is provide with a second polarity, in the example a negative voltage. This allows only the first drive device 330 to be operated whereas the second drive device 332 is not operated independent on the status of the second switch 324.

This is reached by the electronic elements in form of the diodes 336, 338. The diodes 336, 338 are driven in a block direction in case the second polarity is provides whereas the diodes 336, 338 are driven in a pass direction in case the first polarity is provided by the first switch 322.

Depending on the status of the second switch 324 the first drive device 330 is operated in a first direction or a second direction. In case the second switch 324 provides a first polarity, e.g. a positive voltage, to the first subsection 326 and thus to the first drive device 330 the first drive device 330 is operated in the first direction whereas in the second status of the second switch 324 the second subsection 326 and thus the first drive device 330 is provided with a second polarity, e.g. a negative voltage, the first drive device 330 is operated in the second direction.

In case the first switch 322 provides the second subsection 328 with the first polarity, the first drive device 330 cannot be operated irrespective of the status of the second switch 324, whereas the second drive device 332 is operated in the third direction or the fourth direction depending on the status of the second switch 324. In case the second switch 324 provides the first polarity to the second subsection 328 the second drive device 332 is operated in the third direction whereas in case the second switch 324 provides the second polarity to the second subsection 328 the second drive device 332 is operated in the fourth direction.

FIG. 4B illustrates a schematic of a circuitry 320′ usable to implement the claimed method. The circuitry 320′ is connected to a vehicle module in form of a Door Zone Module (DZM) 340′. Alternatively the circuitry may comprise the vehicle module or the circuitry might be incorporated in the vehicle module, in particular the DZM 340′.

The DZM 340′ is connected to a not shown first power source of the vehicle and a not shown second power source of the vehicle. Furthermore the DZM 340′ comprises respective not shown first and second switches. The DZM 340′ comprises a first output 342′ having output contacts Out 1 and Out 2 and a second output 344′ having output contacts Out 3 and Out 4.

In the example the DZM 340′ provides at the output 342′ a first signal provided by the first power source with a maximum current of 0.5 A whereas a second signal is provided at the output 344′ with a maximum current of 3 A.

The first and second signal act as a power supply for a first drive device 330′, in particular a first motor 350′, and a second drive device 332′, in particular a second motor 352′, respectively, in the following way.

The first output 342′ is connected to a first input 346′ of the circuitry 320′ having input contacts In 1 and In 2, whereas the second output 344′ is connected to a second input 348′ of the circuitry 320′ having input contacts In 23 and In 4. The circuitry 320′ comprises a drive device selection module 354′ connected to the first input 346′ and a direction selection module 356′ connected to the second input 348′.

Depending on the polarity of the first signal provided to the first input 346′ the drive device selection module 354′ switches the power supply either to a first drive device driver 358′ or a second drive device driver 360′. The first drive device driver 358′ is connected to the first drive device 330′, in particular the first motor 350′, whereas the second drive device driver 360′ is connected to the second drive device 332′, in particular the second motor 352′.

For example in case the first output contact Out 1 of the first output 342′ is at a potential of 13.5 V and the second output contact Out 2 of the first output 342′ is at a ground potential a first signal of 13.5 V with a first polarity is provided to the first input 346′. Based on the first signal the motor selection module 354′ provides a respective signal to the second drive device driver 360′ such that a voltage of 13 V is provided to the second drive device 332′, in particular the second motor 352′. By this first signal with the first polarity the first drive device 330′, in particular the first motor 350′, is not provided with power, in other words is switched off.

In case the first output contact Out 1 of the first output 342′ is at a ground potential and the second output contact Out 2 of the first output 342′ is at a potential of 13.5 V a first signal of-13,5 V with a second polarity being opposite the first polarity is provided to the first input 346′. Based on the first signal the motor selection module 354′ provides a respective signal to the first drive device driver 358′ such that a voltage of 13 V is provided to the first drive device 330′, in particular the first motor 350′. By this first signal with the second polarity the second drive device 332′, in particular the second motor 350′, is not provided with power, in other words is switched off.

Thus based on the polarity of the first signal via the drive device selection module 354′ it is selected whether the rearview device is moved around a first axis, e.g. a fold axis, by the second motor 352′ or a second axis, e.g. a tilt axis, by the first motor 350′.

The drive devices 330′, 332′ and motors 352′, 350′ are thus controlled such that they are not driven simultaneously but only one of them is operated at a time.

Depending on a second signal provided to the second input 348′, in particular its polarity, the first drive device 330′ or the second drive device 332′ is operated in different directions. In case the second signal provides a first polarity, e.g. a positive voltage of 13.5 V, to the second input 348′ by the drive device direction module 356′ the first drive device driver 358′ and/or the second drive device driver 360′ are provide with a signal such that a positive power supply is provided to the first motor 350′ or the second motor 352′. This polarity of the power supply let (depending on the first signal and/or the drive device selection module 354′ as described before) the motor 350′ turn in a first direction or let the motor 352′ turn in a third direction.

In case the second signal provides a second polarity opposite to the first polarity, e.g. a negative voltage of-13,5 V, to the second input 348′ by the drive device direction module 356′ the first drive device driver 358′ and the second drive device driver 360′ are provide with a signal such that a negative power supply is provided to the first motor 350′ or the second motor 352′. This polarity of the power supply let (depending on the first signal and/or the drive device selection module 354′ as described before) the motor 350′ turn in a second direction being opposite to the first direction or let the motor 352′ turn in a fourth direction being opposite to the third direction.

The actuator furthermore comprises a sensing device 362′ allowing the sensing of at least one parameter of the first drive device 330′, in particular the first motor 350′, and/or the second drive device 332′, in particular the second motor 352′. For example the speed and the direction of rotation of the first motor 350′ and/or the second motor 352′ is sensed. The readings of the sensing device 362′ is in particular provided to the DZM 340′, for example via feedback line 364′. This feedback allows a control of the first and second signal to ensure the correct rotation speed and direction.

FIG. 4C shows an example of a realization of the circuitry 320′. In particular the inner structure and components of the drive device selection module 354′, the direction selection module 356′, the drive device driver 358′ and the drive device driver 360′ are shown.

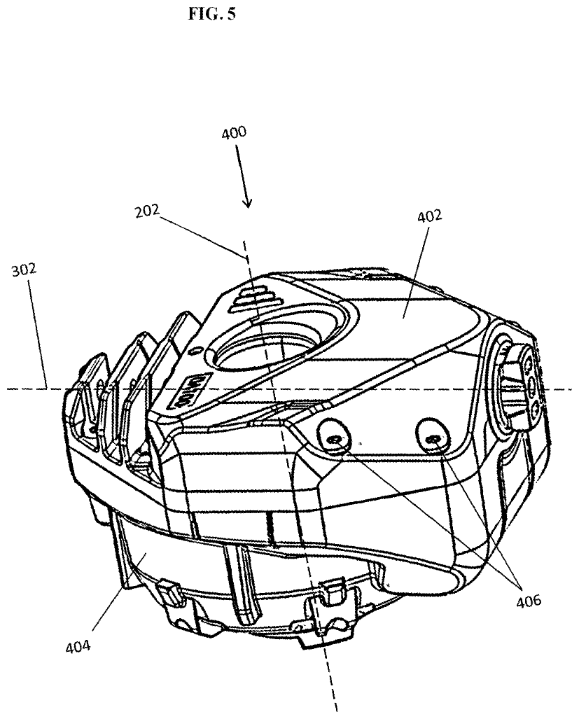

FIG. 5 illustrates an actuator in accordance with aspects of the present disclosure. Although specific embodiments of the actuator are explained it is to be understood that the implementation of the claimed method and the claimed actuator is not restricted to this specific actuator shown in the FIGS. 5 to 43 but might be realized in any actuator for a rearview assembly comprising two drive devices.

As shown in the figure, actuator 400 includes axis 202, axis 302, an upper housing 402, a lower housing 404, and fasteners 406.

Upper housing 402 and lower housing 404 are joined together using fasteners 406 so that they may house and seal the internal components of actuator 400. Fasteners 406 may be any known fastener or fastening method, non-limiting examples of which include bolts, clips, or pins. In this example, fasteners 406 are screws.

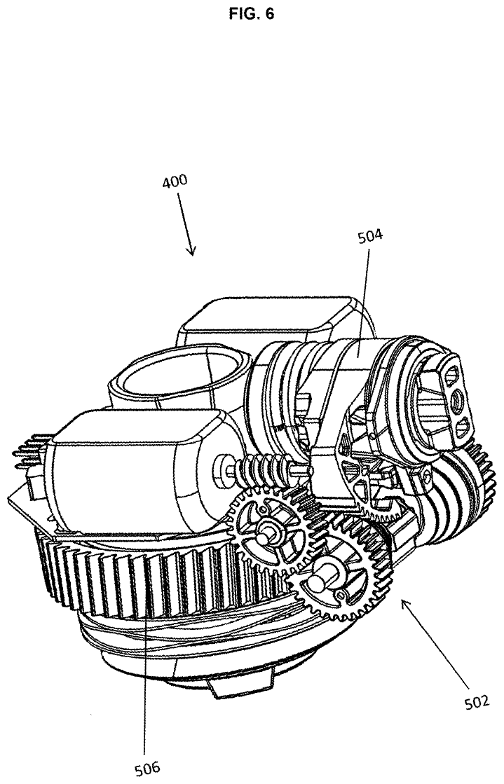

FIG. 6 illustrates actuator 400 with upper housing 402 and lower housing 404 of FIG. 5 removed in accordance with aspects of the present disclosure.

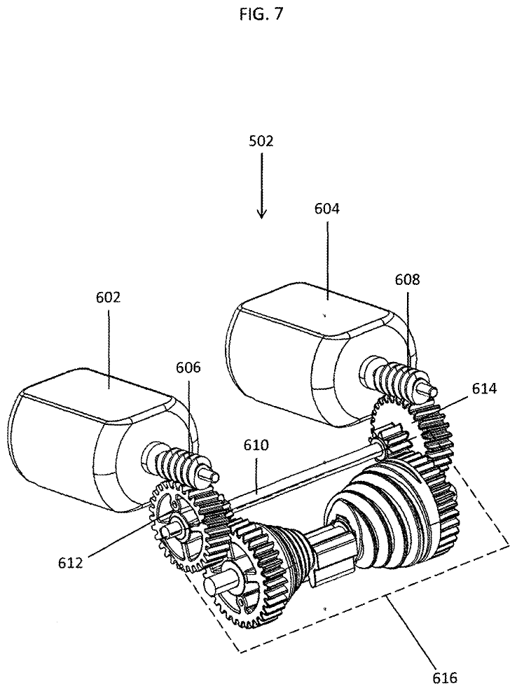

As shown in the figure, actuator 400 includes a gear assembly 502, a tilt drive 504, and a fold drive 506. Tilt drive 504 is operable to rotate mirror head 206 around axis 302, and fold drive 506 is operable to rotate mirror head 206 around axis 202. The operation and arrangement of gear assembly 502, tilt drive 504, and fold drive 506 will now be described with additional reference to FIGS. 7-43.

FIG. 7 illustrates a perspective view of gear assembly 502 in accordance with aspects of the present disclosure.

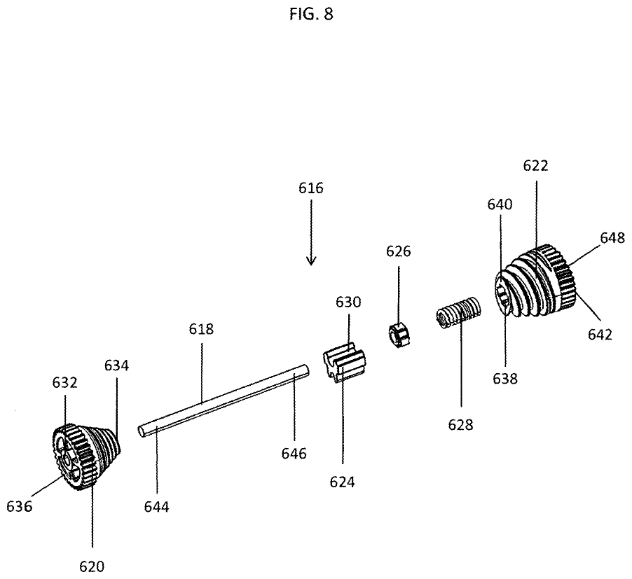

As shown in the figure, gear assembly 502 includes a first drive device in form of a motor 602, in particular a DC motor, a second drive device in form of a motor 604, in particular a DC motor, a worm gear 606, a worm gear 608, an intermediate spindle 610, an intermediate tilt gear 612, an intermediate fold gear 614, and a gear sub assembly 616. The operation of gear assembly 502 and gear sub assembly 616 will now be described with additional reference to FIGS. 8-15.

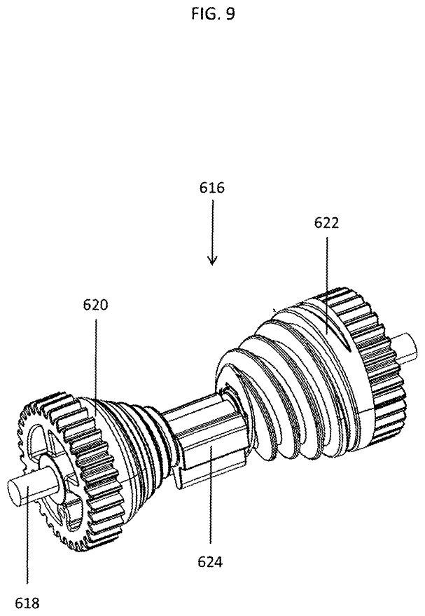

FIG. 8 illustrates an exploded view of gear sub assembly 616 and FIG. 9 illustrates gear sub assembly 616 fully assembled in accordance with aspects of the present disclosure. As shown in the figure, gear sub assembly 616 includes a spindle 618, a secondary tilt gear 620, a secondary fold gear 622, a slide 624, a worm insert 626, and a biasing element 628. In this example variation, biasing element 628 is a spring. However in other variations, biasing element 628 may be any element operable to provide a biasing force.

To assemble gear sub assembly 616, first end 644 of spindle 618 is inserted into aperture 632 of secondary tilt gear 620. Next, slide 624 is inserted onto second end 646 of spindle 618 via channel 630, the contour of channel 630 matches that of spindle 618 so that it may be attached to spindle 618. Once attached, slide 624 is moved along spindle 618 from second end 646 towards first end 644 until it abuts against boss 634 of secondary tilt gear 620. After slide 624 has been attached, worm insert 626 is placed onto second end 646 of spindle 618 followed by biasing element 628. At this time secondary fold gear 622 is arranged such that second end 646 of spindle 618 may be insert through cavity 638 and aperture 648. Once secondary fold gear 622 has been placed onto spindle 618 it can be moved from second end 646 towards first end 644 of spindle 618 until boss 640 abuts against slide 624.

Secondary fold gear 622 is arranged such that during the assembly of gear sub assembly 616, biasing element 628 and worm insert 626 are able to fit inside of cavity 638. Biasing element 628 and worm insert 626 arranged inside of cavity 638 enables secondary fold gear 622 to be slid along spindle 618 until it abuts against slide 624.

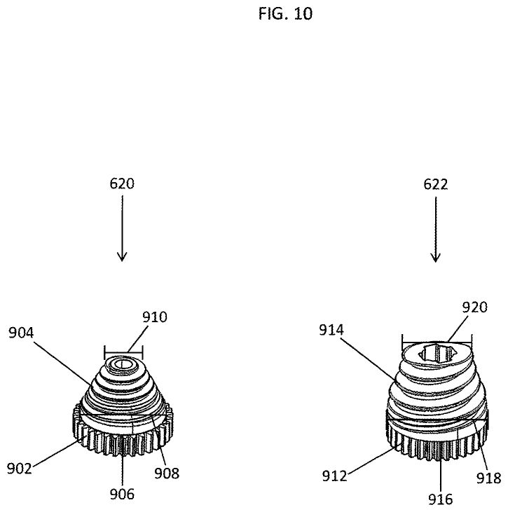

FIG. 10 illustrates secondary tilt gear 620 and secondary fold gear 622 in accordance with aspects of the present disclosure. As shown in the figure, secondary tilt gear 620 includes a spur gear portion 902 and a worm gear portion 904. Secondary fold gear 622 includes a spur gear portion 912, and a worm gear portion 914.

The secondary tilt gear 620 and secondary fold gear 622 are formed as a single structure comprising two different gear portions. Secondary tilt gear 620 is formed by spur gear portion 902 and worm gear portion 904 and secondary fold gear 622 is formed by spur gear portion 912 and worm gear portion 914. Transition point 906 marks the transition from spur gear portion 902 to worm gear portion 904 of secondary tilt gear 620 and transition point 916 marks the transition from spur gear portion 912 to worm gear portion 914 of secondary fold gear 622. In this example variation, secondary tilt gear 620 and secondary fold gear 622 are formed from spur gear portions 902, 912 and worm gear portions 904, 914. In other example variations, secondary tilt gear 620 and secondary fold gear 622 may be formed from a combination of any number of different types of gears.

The formation of secondary tilt gear 620 and secondary fold gear 622 as a single component, each comprising a spur gear portion and a worm gear portion helps prevent backlash within gear assembly 502, tilt drive 504, and fold drive 506 of FIG. 6.

A first end of worm gear portion 904, located at transition point 906, has a diameter shown by line 908. A second end of worm gear portion 904, opposite of its first end, has a diameter shown by line 910, where diameter 910 is smaller than diameter 908. Similarly, a first end of worm gear portion 914, located at transition point 916, has a diameter shown by line 918. A second end of worm gear portion 914, opposite of its first end, has a diameter shown by line 920, where diameter 920 is smaller than diameter 908. The relationship of worm gear portion 904 and worm gear portion 914 is such that diameter 908 is smaller than diameter 918 and diameter 910 is smaller than diameter 920.

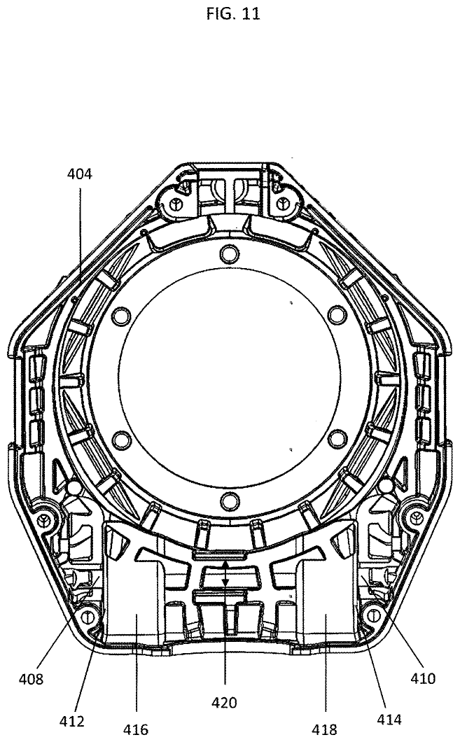

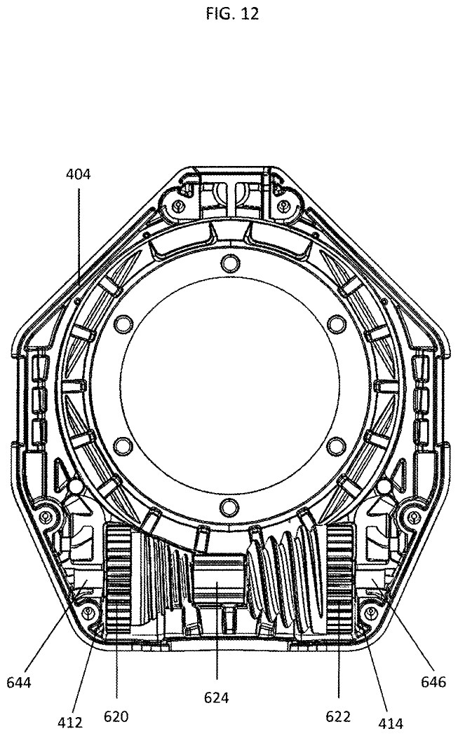

FIG. 11 illustrates lower housing 404 without gear sub assembly 616 installed and FIG. 12 illustrates lower housing 404 with gear sub assembly 616 installed in accordance with aspects of the present disclosure.

As shown in the figure, lower housing 404 includes a bearing 408, a bearing 410, an end surface 412, an end surface 414, a recess 416, a recess 418, and a channel 420. The listed components of lower housing 404 are designed such that they may receive and affix gear sub assembly 616 without impeding the operation of gear sub assembly 616 within actuator 400 of FIG. 5.

Bearing 408 is arranged to receive the first end 644 (FIG. 8) of spindle 618 and bearing 410 is arranged to receive the second end 646 (FIG. 8) of spindle 618. Recess 416 is arranged to receive secondary tilt gear 620 such that its end surface 636 (FIG. 8) abuts against end surface 412 and recess 418 is arranged to receive secondary fold gear 622 such that its end surface 642 (FIG. 8) abuts against end surface 414. In this configuration, slide 624 is received in channel 420 of lower housing 404.

Since lower housing 404 is a single part, the distance between end surface 412 and end surface 414 is fixed. The fixed distance between end surface 412 and end surface 414 means that gear sub assembly 616 is installed into lower housing 404 with worm insert 626 and biasing element 628 located within cavity 638 of secondary fold gear 622. Biasing element 628 is compressed so it may fit inside of cavity 638, once gear sub assembly 616 is installed within lower housing 404, biasing element 628 will then exert a force along the components of gear sub assembly 616.

The force exerted by biasing element 628 forces secondary tilt gear 620 against end surface 412 via worm insert 626 and slide 624, and also forces secondary fold gear 622 against end surface 414. The application of force by biasing element 628 improves the meshing between secondary tilt gear 620 and tilt drive 504 and between secondary fold gear 622 and fold drive 506. The improved meshing reduces backlash within gear sub assembly 616 that would occur if secondary tilt gear 620 or secondary fold gear 622 were able to freely slide along spindle 618.

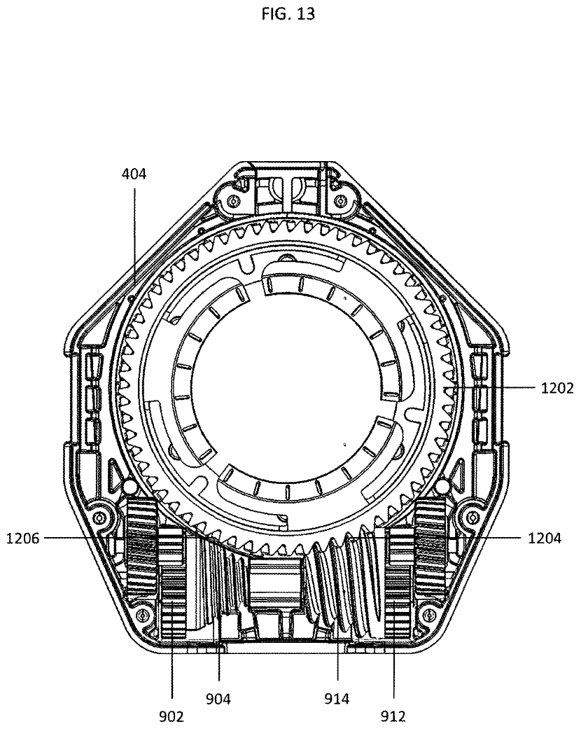

FIG. 13 illustrates the relative positions of gear sub assembly 616 and fold drive 506 in accordance with aspects of the present disclosure. As shown in the figure, gear sub assembly 616 is installed in lower housing 404 as described above in FIG. 11-12. FIG. 13 additionally shows primary fold gear 1202 of fold drive 506 in its installed position within actuator 400.

Point 1204 shows the meshing between worm gear portion 914 and the teeth of primary fold gear 1202, and point 1206 shows a gap between the teeth of worm gear portion 904 and primary fold gear 1202. Since worm gear portion 914 has a diameter 918 and diameter 920 that is larger than the corresponding diameters of worm gear portion 904, namely diameter 908 and diameter 910, worm gear portion 914 is operable to mesh with the teeth of primary fold gear 1202 while worm gear portion 904 does not. In this manner, secondary fold gear 622 can be rotated independent of secondary tilt gear 620 in order to operate fold drive 506.

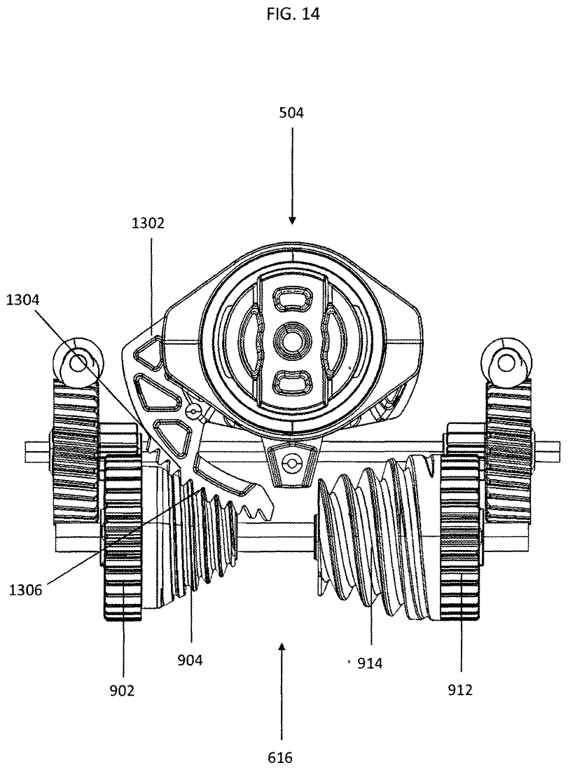

FIG. 14 illustrates the relative positions of gear sub assembly 616 and tilt drive 504 in accordance with aspects of the present disclosure. As shown in the figure, gear sub assembly 616 is shown in its installed position within lower housing 404, however for clarity, lower housing 404 is not shown. The figure additionally shows primary tilt gear 1302 from tilt drive 504 in its installed position.

Point 1306 shows the meshing between worm gear portion 904 and the teeth of primary tilt gear 1302. The relationship of the diameters between worm gear portion 914 and worm gear portion 904 does not affect meshing with primary tilt gear 1302 in the same manner the relationship affected meshing with primary fold gear 1202 of FIG. 13.

Primary tilt gear 1302 has a tilt gear extension 1304 which extends in the direction of worm gear portion 904 and away from worm gear portion 914. This extension allows meshing between worm gear portion 904 and the teeth of primary tilt gear 1302 without interference from worm gear portion 914 even though worm gear portion 914 has a larger diameter, shown as diameter 918 of FIG. 11, when compared to diameter 908 of FIG. 11. In this manner, secondary tilt gear 620 can be rotated independent of secondary fold gear 622 in order to operate tilt drive 504.

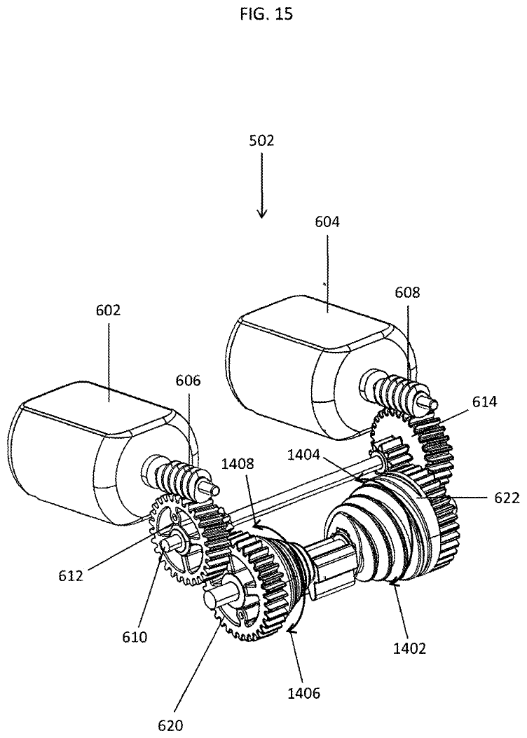

FIG. 15 illustrates a perspective view of gear assembly 502 during operation in accordance with aspects of the present disclosure. As shown in the figure, gear assembly 502 includes the elements of gear assembly 502 of FIG. 7 described above and for purposes of brevity, will not be described again here. FIG. 15 additionally includes a first fold gear direction 1402, a second fold gear direction 1404, a first tilt gear direction 1406, and a second tilt gear direction 1408.

If operation of tilt drive 504 is requested by the vehicle operator in order to adjust mirror head 206 of FIG. 2, power is delivered from an external source (not shown), in particular via the circuitry shown in FIG. 4 and explained above to motor 602, causing motor 602 to turn worm gear 606 in a first direction. As worm gear 606 rotates, it drives intermediate tilt gear 612, which then turns secondary tilt gear 620. In this example, motor 602 turning in first direction, in particular by putting the first switch 322 and the second switch 324 into the respective, before described status, results in secondary tilt gear 620 rotating in first tilt gear direction 1406. In particular first switch 322 is put in the status allowing to drive the first drive device 330 in form of motor 602 and prohibiting a driving of the second drive device 332 in from of motor 604.

Alternatively, if motor 602 rotates worm gear 606 in a second direction, in particular by changing the status of switch 324, it will drive intermediate gear 612 to turn secondary tilt gear 620 in second tilt gear direction 1408. The rotation of secondary tilt gear 620 imparts a rotation to primary tilt gear 1302 (FIG. 14) in order to operate tilt drive 504 and rotate mirror head 206 (FIG. 3A) about axis 302 FIG. 3A).

Briefly referring to FIG. 12, when gear sub assembly 616 is installed in lower housing 404, the first end 644 and second end 646 of spindle 618 are supported by bearing 408 and bearing 410 respectively. The pressure exerted by biasing element 628 limits travel along the axis of spindle 618 by forcing secondary tilt gear 620 against end surface 412, which enables secondary tilt gear 620 to be driven via intermediate tilt gear 612. This arrangement allows secondary tilt gear 620 to rotate around spindle 618, while keeping spindle 618 fixed in place.

Referring back to FIG. 15, if operation of the fold drive is requested by the vehicle operator, in particular by putting the first switch 322 into a state allowing driving of the second drive device 332 in form of motor 604 and prohibiting the driving of the first drive device 330 in form of motor 602, in order to adjust mirror head 206, power is first delivered to motor 604 from an external source (not shown). Upon receiving power, motor 604 will rotate worm gear 608 in a first direction which drives intermediate fold gear 614. The rotation of intermediate fold gear 614 rotates secondary fold gear 622, which in this example is first fold gear direction 1402, representing a third direction. Alternatively, if motor 604 rotates worm gear 608 in a second direction, it will drive intermediate fold gear 614 to turn secondary fold gear 622 in a second fold gear direction 1404, representing a fourth direction. The rotation of secondary fold gear 622 imparts a rotation to primary fold gear 1202 in order to operate fold drive 506 and rotate mirror head 206 (FIG. 2A) about axis 202 (FIG. 2A).

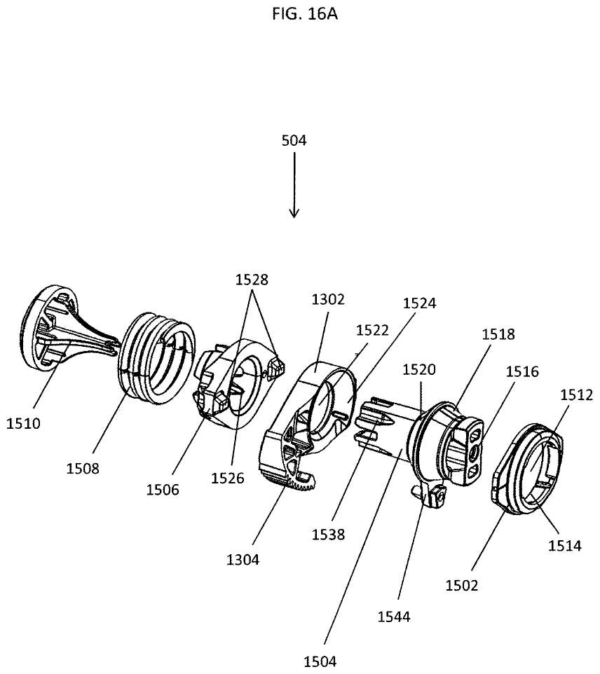

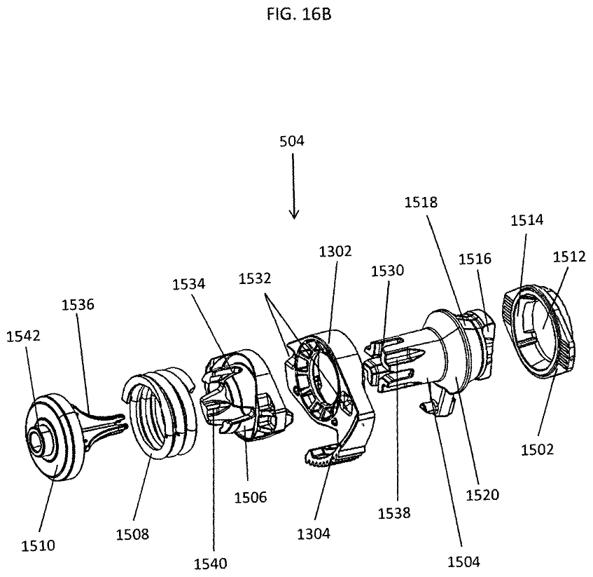

The rotation of secondary fold gear 622 is similar to that of secondary tilt gear 620 described above, since spindle 618 of gear sub assembly 616 is fixed in place, secondary fold gear 622 is free to rotate around spindle 618. In this manner, operation of the fold drive 506 and tilt drive 504 can be achieved simultaneously. However, simultaneous operation of fold drive 506 and tilt drive 504 is not required, the arrangement of gear assembly 502 allows for independent operation of tilt drive 504 or fold drive 506. The operation of gear assembly 502 and tilt drive 504 will now be described with reference to FIGS. 16A-25.

FIG. 16A illustrates an exploded view of the front of tilt drive 504 in accordance with aspects of the present disclosure. FIG. 16B illustrates an exploded view of the back of tilt drive 504 in accordance with aspects of the present disclosure. As shown in the figures, tilt drive 504 includes primary tilt gear 1302, a tilt journal 1502, a tilt axle 1504, a tilt clutch 1506, a tilt spring 1508, and a tilt inner 1510.

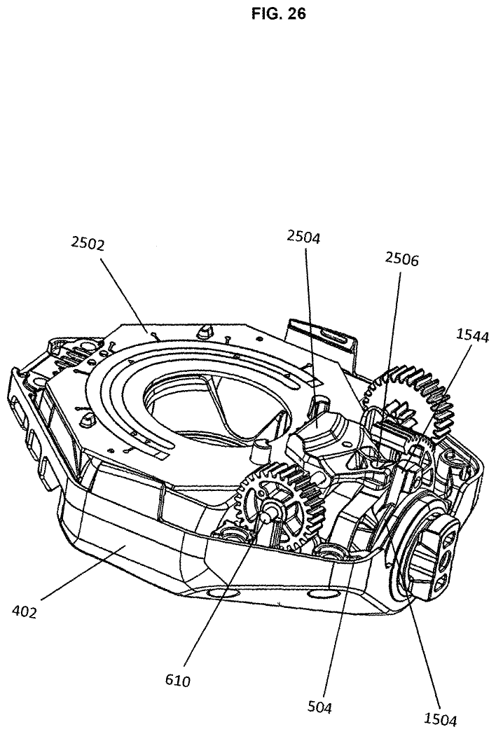

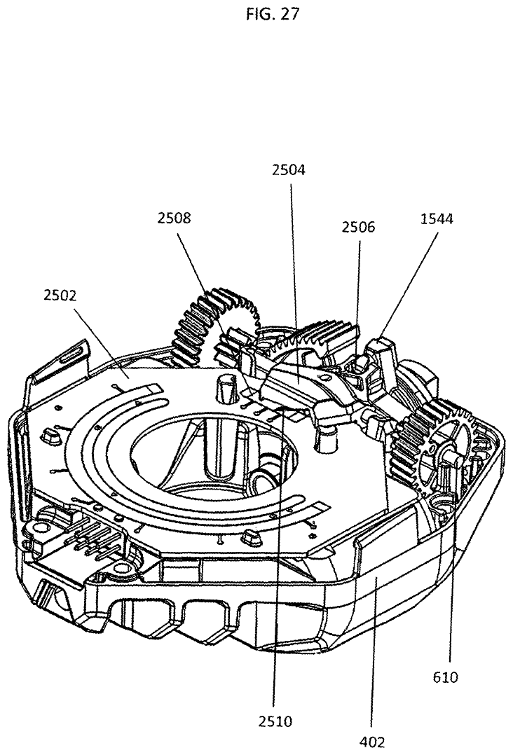

Tilt axle 1504 further comprises taper 1518 which cooperates with taper 1514 of tilt journal 1502. Tilt journal 1502 is arranged such that it is retained in place between upper housing 402 and lower housing 404 of actuator 400. Tilt journal 1502 being retained between upper housing 402 and lower housing 404 ensures the correct location of taper 151, so that the cooperation between taper 1514 and taper 1518 leads to tilt axle 1504 being properly aligned. Without tilt journal 1502, any mismatch between the alignment of upper housing 402 and lower housing 404 would result in a step during the operation of tilt drive 504. A step during the operation of tilt drive 504 would increase friction, create an audible noise as well as create an in-balance of the operation of tilt axle 1504. Tilt axle 1504 additionally includes tilt wiper carrier connector 1544 for use with a tilt memory system. A tilt memory system will be described later with reference to FIGS. 26-27.

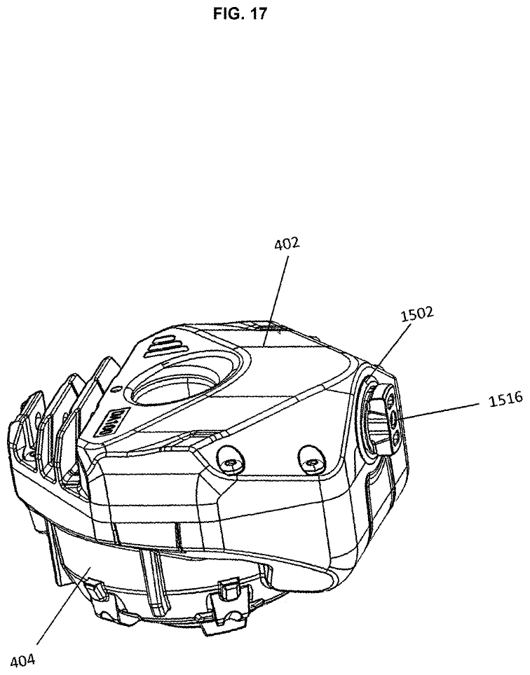

FIG. 17 illustrates the location of tilt journal 1502 and attachment point 1516 of tilt drive 504 in accordance with aspects of the present disclosure.

The abutment of taper 1518 and taper 1514 allows attachment point 1516 of tilt axle 1504 to protrude through aperture 1512 of tilt journal 1502. The extension of attachment point 1516 through aperture 1512 provides clearance for mirror head 206 (not shown) to be attached to attachment point 1516 while maintaining clearance with the rest of actuator 400. This attachment enables the transfer of motion of tilt drive 504 to mirror head 206 such that it may be rotated about axis 302 of FIG. 3 in a first tilt direction 304 or a second tilt direction 306. In this form, attachment point 1516 is directly connected to the mirror head. It is also within the scope of this disclosure an indirect attachment configuration to the mirror head 206 may also be used.

Referring back to FIGS. 16A-B, tilt axle 1504 further comprises taper 1520 which cooperates with taper 1524 of primary tilt gear 1302. When tilt drive 504 is assembled and installed in actuator 400, tilt spring 1508 applies pressure to push primary tilt gear 1302 against tilt axle 1504. Taper 1520 and taper 1524 act together to center primary tilt gear 1302 on tilt axle 1504.

Further, the frictional force created at the interface of taper 1520 and taper 1524 results in tilt axle 1504 rotating when primary tilt gear 1302 is driven.

Tilt clutch 1506 includes protrusion 1528 and primary tilt gear 1302 includes recess 1532, where the geometry of protrusion 1528 is such that it fits into recess 1532. Tilt spring 1508 applies a pressure which holds tilt clutch 1506 against primary tilt gear 1302 such that protrusion 1528 is restrained in recess 1532, which results in tilt clutch 1506 rotating when primary tilt gear 1302 is rotated during operation.

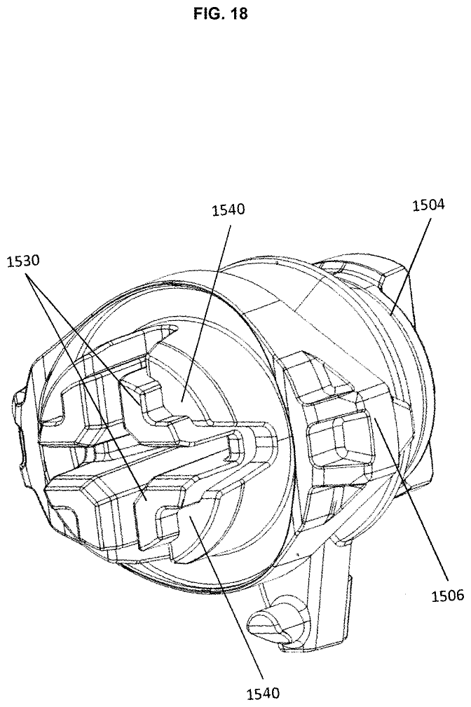

FIG. 18 illustrates the arrangement of tilt axle 1504 and tilt clutch 1506 of tilt drive 504 in accordance with aspects of the present disclosure. During the assembly of tilt drive 504, tilt axle 1504 is inserted through aperture 1522 of primary tilt gear 1302 and aperture 1526 of tilt clutch 1506. To insert tilt axle 1504 through tilt clutch 1506, protrusion 1540 of tilt clutch 1506 aligns with slot 1538 of tilt axle 1504. The fitting of protrusion 1540 into slot 1538 rotationally locks tilt clutch 1506 and tilt axle 1504. In this manner, the rotation of tilt axle 1504 always results in the rotation of tilt clutch 1506.

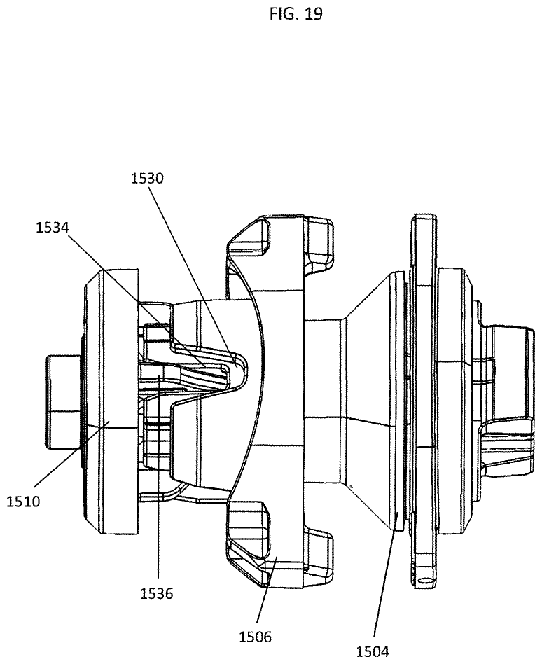

FIG. 19 illustrates the arrangement of tilt axle 1504, tilt clutch 1506, and tilt inner 1510 of tilt drive 504 in accordance with aspects of the present disclosure. Tilt inner 1510 includes extension 1536, which fits into slot 1534 of tilt clutch 1506 and slot 1530 of tilt axle 1504. As described above, tilt axle 1504 is insert through primary tilt gear 1302 and tilt clutch 1506. Then, tilt axle 1504 is then insert through tilt spring 1508 and on to tilt inner 1510 such that extension 1536 of tilt inner 1510 fits into slot 1534 of tilt clutch 1506 and slot 1530. Once assembled the arrangement of protrusion 1540 of tilt clutch 1506 and slot 1538 of tilt axle 1504 as well as the arrangement of extension 1536 of tilt inner 1510 with slot 1534 of tilt clutch 1506 and slot 1530 of tilt axle 1504 ensures that tilt inner 1510, tilt clutch 1506, and tilt axle 1504 are rotationally locked.

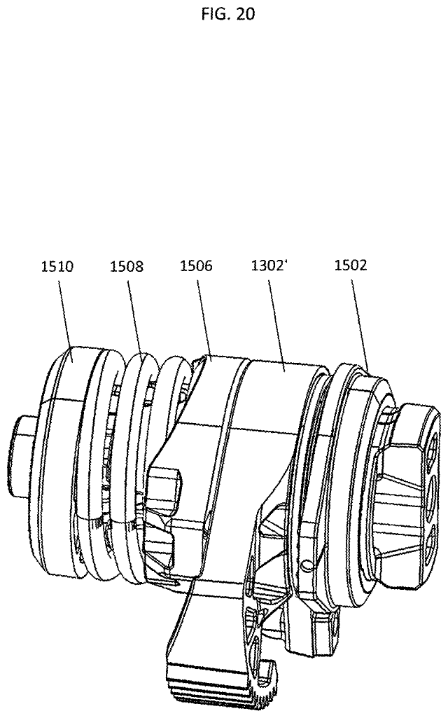

FIG. 20 illustrates a perspective view of tilt drive 504 fully assembled in accordance with aspects of the present disclosure. As shown in the figure, tilt drive 504 has been fully assembled, however for purposes of clarity, even though tilt spring 1508 is shown compressed, tilt spring 1508 cannot be held in a compressed state until tilt drive 504 has been installed in its location within actuator 400. Similarly, tilt journal 1502 is arranged between upper housing 402 and lower housing 404, however is shown in the figure to illustrate the relation between tilt journal 1502 and the rest of tilt drive 504.

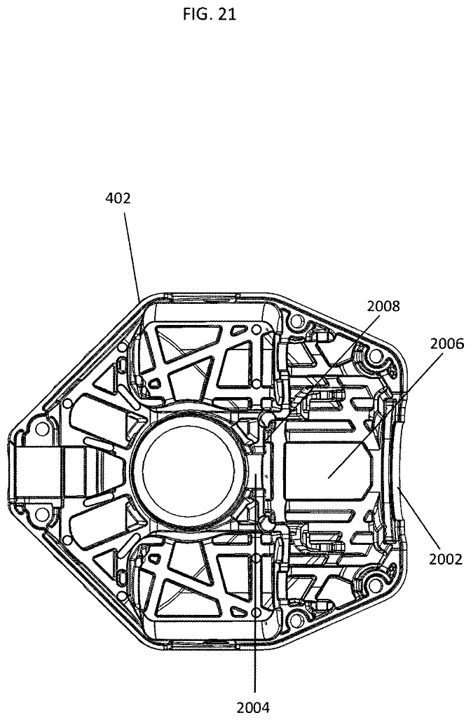

FIG. 21 illustrates a bottom-up view of upper housing 402 in accordance with aspects of the present disclosure. As shown in the figure, upper housing 402 includes an aperture 2002, a bearing 2004, a recess 2006, and a surface 2008. Aperture 2002 is arranged to receive tilt journal 1502, bearing 2004 is arranged to receive support 1542 of tilt inner 1510 such that tilt inner 1510 abuts against surface 2008, and recess 2006 is arranged to receive assembled tilt drive 504.

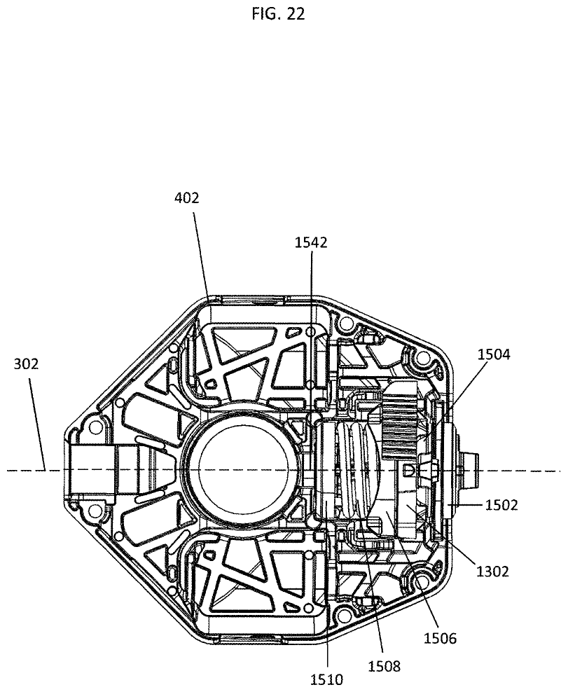

FIG. 22 illustrates tilt drive 504 assembled within upper housing 402 in accordance with aspects of the present disclosure. In the installed position within upper housing 402, tilt inner 1510 abuts surface 2008 which is in a fixed position, and tilt spring 1508 is in a compressed state and exerts pressure against tilt inner 1510 and tilt clutch 1506. With tilt spring 1508 compressed and tilt inner 1510 abutting surface 2008, tilt spring 1508 exerting pressure holds tilt clutch 1506 against primary tilt gear 1302. Tilt clutch 1506 being forced against primary tilt gear 1302 results in protrusion 1528 being retained within recess 1532 of primary tilt gear 1302.

The force exerted by tilt spring 1508 applies pressure to tilt clutch 1506, which is transferred to primary tilt gear 1302 as described above. The force transferred then holds primary tilt gear 1302 against tilt axle 1504 and tilt axle 1504 against tilt journal 1502, with taper 1524 abutting taper 1520 and taper 1518 abutting taper 1514 respectively. The abutment of taper 1524 against taper 1520 and taper 1518 against taper 1514 forces the alignment of tilt journal 1502, tilt axle 1504, primary tilt gear 1302, and tilt clutch 1506 along axis 302.

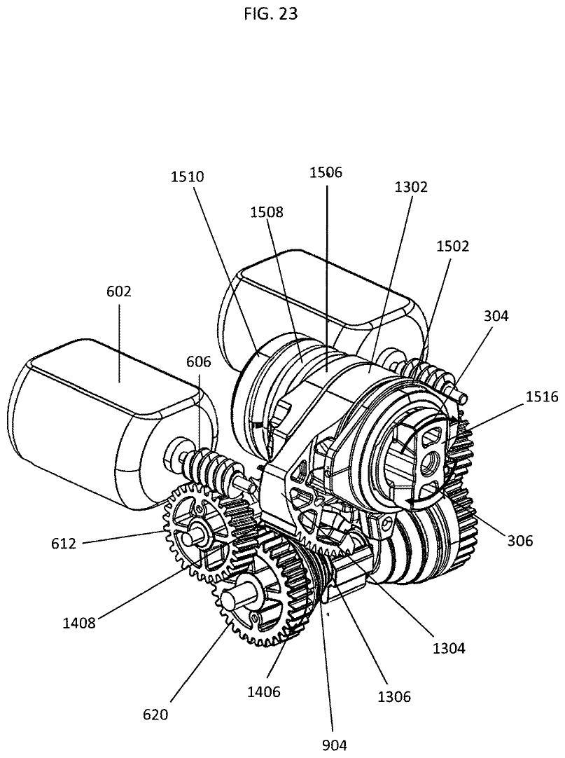

FIG. 23 illustrates the arrangement of gear assembly 502 and tilt drive 504 in their installed positions within actuator 400 of FIG. 5 in accordance with aspects of the present disclosure. As stated above, FIG. 23 illustrates the arrangement of gear assembly 502 and tilt drive 504 in their installed positions within actuator 400. However, for purposes of clarity, all other elements of actuator 400 have been removed.

To operate tilt drive 504, power is delivered to motor 602 from an external source (not shown), such as a vehicle's battery or electrical system, in particular via the circuitry 320. Once supplied with power, in particular by putting the first switch 322 and the second switch into the respective state, first drive device 330 in form of motor 602 will turn worm gear 606, which may then rotate intermediate tilt gear 612, which in turn rotates secondary tilt gear 620. With tilt drive 504 in the installed position, the teeth of tilt gear extension 1304 mesh with the worm gear portion 904 of secondary tilt gear 620 so as secondary tilt gear 620 rotates, it results in the rotation of primary tilt gear 1302. In this example variation, when secondary tilt gear 620 rotates in first tilt gear direction 1406, primary tilt gear 1302 rotates in first tilt direction 304 and secondary tilt gear 620 rotating in second tilt gear direction 1408 results in primary tilt gear 1302 rotating in second tilt direction 306. Additionally, the arrangement of primary tilt gear 1302 and more specifically, tilt gear extension 1304 and secondary tilt gear 620 allows tilt drive 504 to be operated independent of fold drive 506.

As tilt gear extension 1304 is rotated by the rotation of secondary tilt gear 620, primary tilt gear 1302 begins to rotate. Since tilt clutch 1506 is rotationally locked to primary tilt gear 1302 via protrusion 1528 and recess 1532, rotation of primary tilt gear 1302 results in tilt clutch 1506 rotating as well. Further, as described above in FIG. 18, tilt clutch 1506 is rotationally locked to tilt axle 1504 via protrusion 1540 of tilt clutch 1506 and protrusion 1528 of tilt axle 1504. In this manner, rotation of primary tilt gear 1302 results in the rotation of tilt clutch 1506 and tilt axle 1504.

Attachment point 1516 of tilt axle 1504 is attached to mirror head 206, therefore, when tilt axle 1504 rotates the connection between mirror head 206 and attachment point 1516 results in the tilting of mirror head 206 in either first tilt direction 304 or second tilt direction 306 about axis 302. In this manner, mirror head 206 can be actuated such that a reflective element (not shown) attached to mirror head 206 provides an acceptable view rearward of the vehicle. For example, tilt drive 504 can be operated such that mirror head 206 rotates about axis 302 in first tilt direction 304 to the position shown in FIG. 3B. Alternatively, tilt drive 504 may be operated such that mirror head 206 rotates about axis 302 in second tilt direction 306 to the position shown in FIG. 3C. In another variation, tilt drive 504 may be operated in order to rotate mirror head 206 from either the position shown in FIG. 3B or FIG. 3C to the position shown in FIG. 3A.

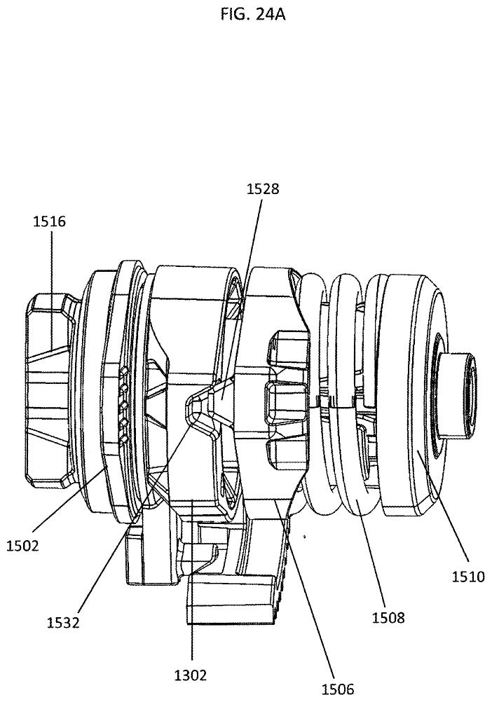

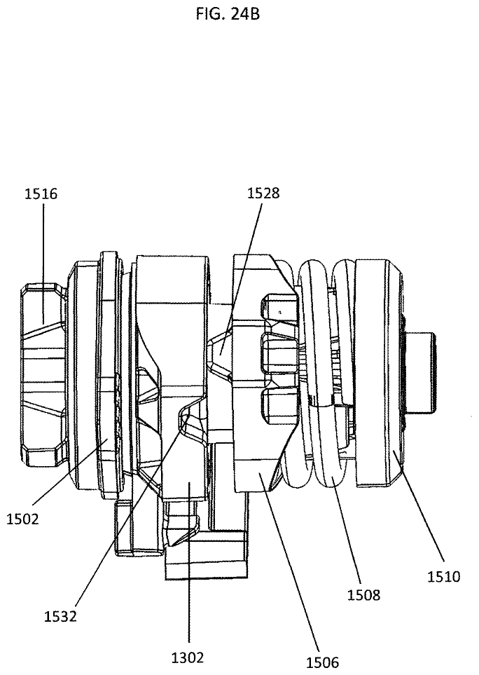

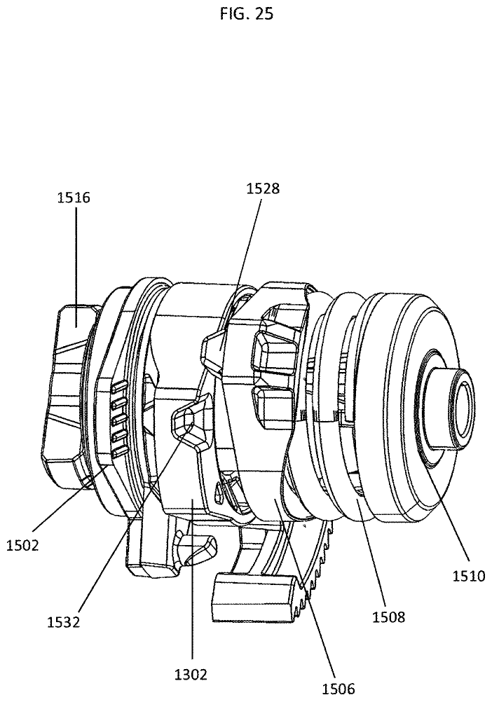

As stated above, with mirror head 206 attached to attachment point 1516 of tilt axle 1504, when tilt drive 504 is electrically operated, it results in the adjustment of mirror head 206 about axis 302. Conversely, if mirror head 206 is manually adjusted, the connection between mirror head 206 and tilt axle 1504 via attachment point 1516 results in the rotation of tilt axle 1504. The operation of tilt drive 504 during manual operation will now be described with additional reference to FIGS. 24A-25.

FIG. 23A illustrates the operation of tilt clutch 1506 during manual operation in accordance with aspects of the present disclosure. FIG. 24B illustrates the operation of tilt clutch 1506 during manual operation in accordance with aspects of the present disclosure. FIG. 25 illustrates tilt clutch 1506 sliding along primary tilt gear 1302 when manually disengaged in accordance with aspects of the present disclosure.

Mirror head 206 will rotate as it is manually adjusted which results in the rotation of tilt axle 1504 via attachment point 1516. As described above in FIG. 18, since tilt clutch 1506 is rotationally locked with tilt axle 1504, it will rotate as tilt axle 1504 rotates. When mirror head 206 is being adjusted manually, primary tilt gear 1302 is not rotating since there is no power being deliver to motor 602. Therefore, as tilt axle 1504 and tilt clutch 1506 rotate, the edge of protrusion 1528 slides against the edge of recess 1532, tilt clutch 1506 begins to move towards tilt inner 1510 and compress tilt spring 1508 as shown in FIG. 24A.

Tilt axle 1504 and tilt clutch 1506 continue to rotate until protrusion 1528 finally extends out of recess 1532 and tilt clutch 1506 becomes disengaged from primary tilt gear 1302, tilt spring 1508 is compressed as shown in FIG. 24B. Referring to FIG. 25, once disengaged, tilt axle 1504 and tilt clutch 1506 rotate freely as mirror head 206 is manually adjusted and protrusion 1528 may slide along the back surface of primary tilt gear 1302.

Returning mirror head 206 to its drive position can be done through electrical actuation or manually. In the case of manual operation, mirror head 206 can be rotated toward back towards its drive position. Since mirror head 206 is attached to tilt axle 1504 via attachment point 1516, as mirror head 206 rotates so does tilt axle 1504 and tilt clutch 1506. As tilt axle 1504 and tilt clutch 1506 rotate, protrusion 1528 moves towards recess 1532 of primary tilt gear 1302. When protrusion 1528 reaches recess 1532 they interlock and allow the force exerted by tilt spring 1508 to push tilt clutch 1506 against primary tilt gear 1302.

In the case of electrical operation, power is delivered to motor 602 which then rotates primary tilt gear 1302 as described above in reference to FIG. 23. While primary tilt gear 1302 is rotating, tilt axle 1504 and tilt clutch 1506 remain static. Once primary tilt gear 1302 rotates enough such that recess 1532 aligns with protrusion 1528, the force exerted by tilt spring 1508 forces protrusion 1528 into recess 1532 and tilt clutch 1506 to abut against primary tilt gear 1302. At this time, mirror head 206 can be actuated by tilt drive 504 as described above.

In some instances, it may be desirable to have a memory function for use with actuator 400. A memory function would allow the driver of a vehicle to set a specific fold and tilt angle for mirror head 206 that can then be stored. If the position of mirror head 206 is changed, the stored position could then be retrieved at a later time to automatically move mirror head 206 back to the stored position without any fine tune adjustment by the driver. A tilt memory function of actuator 400 will now be described with reference to FIGS. 26-27.

FIG. 26 illustrates a tilt memory system in accordance with aspects of the present disclosure. As shown in the figure, tilt wiper carrier 2504 is attached to intermediate spindle 610 and tilt wiper carrier connector 1544. Tilt wiper carrier connector 1544 is directly connected to tilt axle 1504 as described above in FIG. 16, such that when tilt axle 1504 rotates, so does tilt wiper carrier connector 1544. Tilt wiper carrier 2504 is attached to tilt wiper carrier connector 1544 via slot 2506, so when tilt axle 1504 rotates, tilt wiper carrier 2504 slides along intermediate spindle 610. The rotational motion of tilt axle 1504 results in the linear motion of tilt wiper carrier 2504 which can then be used with a potentiometer system to map and store the tilt position of mirror head 206.

FIG. 27 illustrates an alternative view of a tilt memory system in accordance with aspects of the present disclosure.

As shown in the figure, PCB 2502 is arranged on upper housing 402 and further includes a carbon strip 2508 and tilt wiper carrier 2504 further includes a tilt wiper 2510. Carbon strip 2508 is arranged on PCB 2502 such that tilt wiper 2510 is operable to make direct contact with carbon strip 2508. At this time, when tilt drive 504 is operated, tilt axle 1504 will rotate resulting in tilt wiper carrier 2504 sliding along intermediate spindle 610. As tilt wiper carrier 2504 slides along intermediate spindle 610 so does tilt wiper 2510, which leads to tilt wiper 2510 contacting a different point along carbon strip 2508. Once the desired tilt position of mirror head 206 is reached, a measurement may be taken by a potentiometer (not shown) to record the position where tilt wiper 2510 contacts carbon strip 2508. In order to adjust the tilt angle of mirror head 206 by using the memory system, power may delivered to motor 602 to adjust the tilt angle of mirror head 206 until the potentiometer system detects that the position of tilt wiper 2510 has contacted the point along carbon strip 2508 that matches the stored position of tilt wiper 2510 along carbon strip 2508.

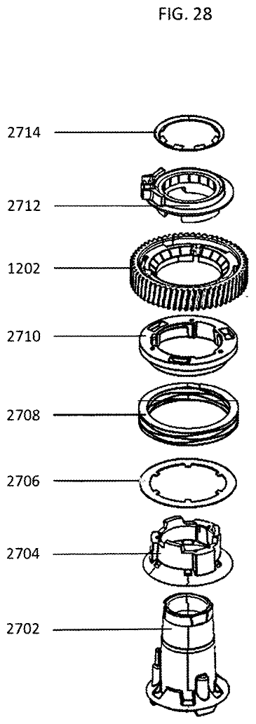

The operation of gear assembly 502 and fold drive 506 will now be described with reference to FIGS. 28-41B.

FIG. 28 illustrates an exploded top-down view of fold drive 506 in accordance with aspects of the present disclosure.

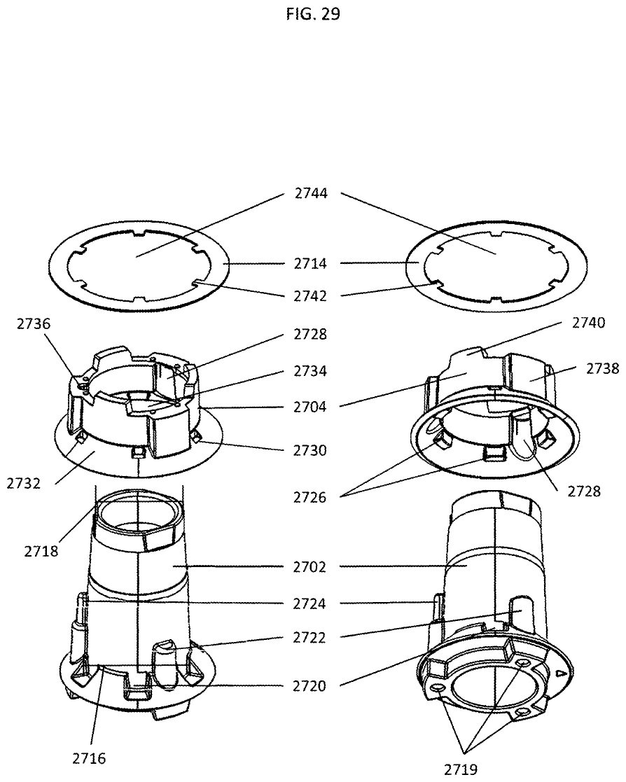

As shown in the figures, fold drive 506 includes primary fold gear 1202, a shaft 2702, a slip collar 2704, a lock ring 2706, a fold spring 2708, a fold clutch 2710, a gear seat 2712, and a retainer 2714. The assembly and arrangement of the elements of fold drive 506 will now be described with additional reference to FIGS. 29-41B.

FIG. 29 illustrates a detailed view of shaft 2702, slip collar 2704, lock ring 2706, and fold spring 2708 of FIG. 27 in accordance with aspects of the present disclosure. The left side of FIG. 29 illustrates a perspective view from the top-down and the right side of FIG. 29 illustrates a perspective view from the bottom-up.

Shaft 2702 has a diameter 2716 at its proximal end and a diameter 2718 at its distal end, where diameter 2716 is larger than diameter 2718, which gives a taper to shaft 2702. Shaft 2702 additionally includes pins 2722 and locator pin 2724. When assembling fold drive 506, slip collar 2704 is placed onto shaft 2702 such that shaft 2702 passes through aperture 2734. To assure the correct alignment of slip collar 2704, locator pin 2724 fits through aperture 2736 of slip collar 2704. Slip collar 2704 additionally includes protrusion 2738 which is designed to fit within a corresponding recess of fold clutch 2710 of FIG. 28. Slip collar 2704 further includes extension 2740 which is operable to be received by a recess of gear seat 2712 of FIG. 28. Shaft 2702 further includes aperture 2719 which are operable to non-moveably fix shaft 2702 to mirror base 204 (not shown).

Aperture 2736 receiving locator pin 2724 ensures that each of pin 2722 fits with a corresponding recess 2728 on the inner circumference of slip collar 2704. Once locator pin 2724 is aligned with aperture 2736 and pin 2722 aligned with recess 2728, slip collar 2704 can be moved along shaft 2702 until protrusion 2726 of slip collar 2704 fit within recess 2720 of shaft 2702.

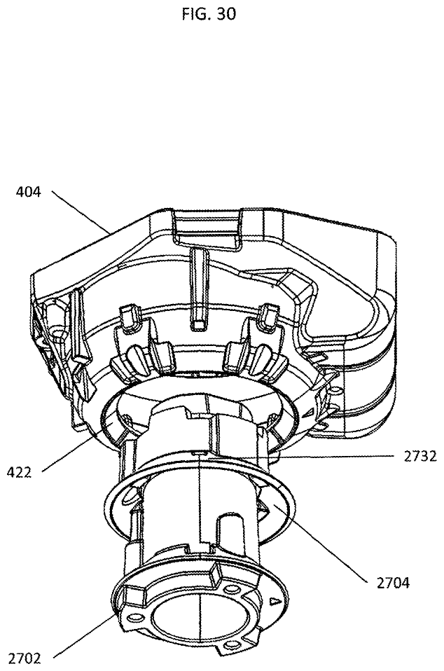

FIG. 30 illustrates the assembly of fold drive 506 with lower housing 404 in accordance with aspects of the present disclosure. As shown in the figure, lower housing 404 includes a taper 422. Once slip collar 2704 has been fixed to shaft 2702, as described above in FIG. 30, lower housing 404 may be assembled with fold drive 506. To assemble lower housing 404 with fold drive 506, lower housing 404 is placed onto shaft 2702 and then lowered until taper 422 of lower housing 404 abuts taper 2732 of slip collar 2704.

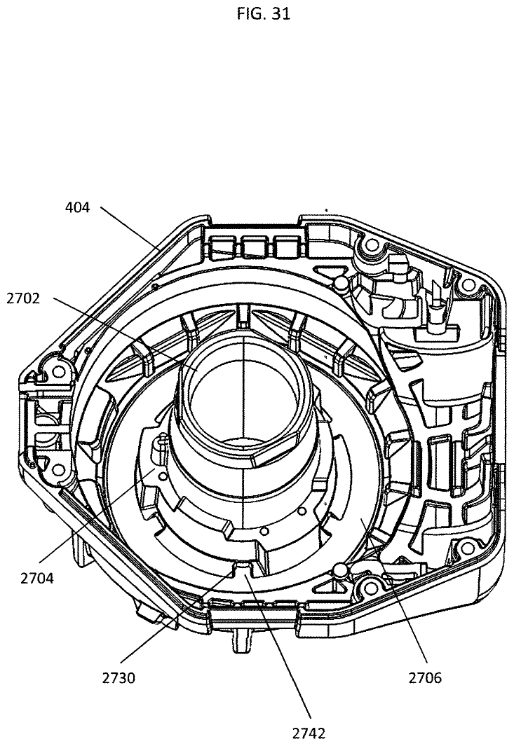

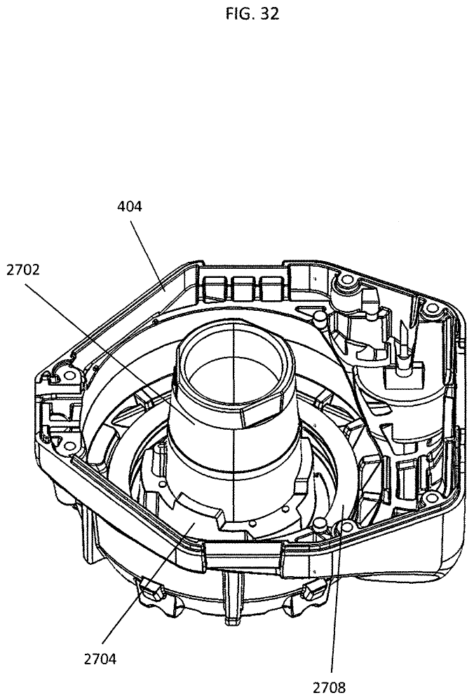

FIG. 31 illustrates lower housing 404 assembled with fold drive 506 in accordance with aspects of the present disclosure. FIG. 32 illustrates shaft 2702, slip collar 2704, lock ring 2706, fold spring 2708, and lower housing 404 assembled in accordance with aspects of the present disclosure. As shown in the figure, once lower housing 404 has been arranged such that taper 422 abuts taper 2732 of slip collar 2704, lock ring 2706 may be installed. Next, lock ring 2706 is arranged such that slip collar 2704 fits inside of aperture 2744 (FIG. 29) and lock ring 2706 can be moved along slip collar 2704 until protrusion 2742 of lock ring 2706 fits within recess 2730 of slip collar 2704. At this time, fold spring 2708 can be placed over shaft 2702 and lowered until it rests on lock ring 2706 as shown in FIG. 32.

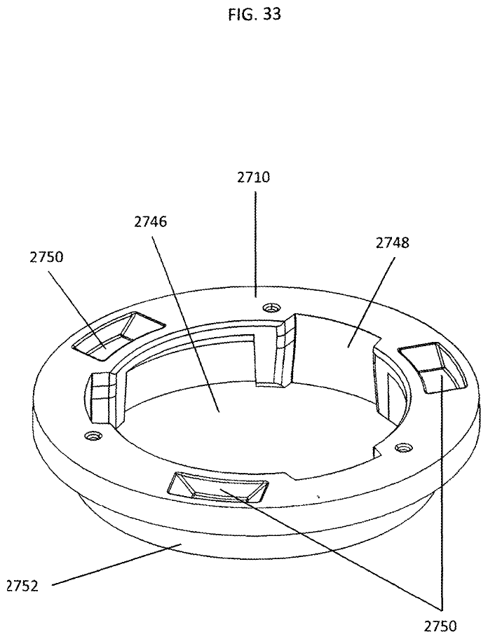

FIG. 33 illustrates fold clutch 2710 in accordance with aspects of the present disclosure. As shown in the figure, fold clutch 2710 includes an aperture 2746, a recess 2748, at least one recess 2750, and an annular extension 2752. Aperture 2746 is operable such that it may allow the passage of shaft 2702 through fold clutch 2710. Recess 2748 is operable to receive extension 2740 of slip collar 2704 of FIG. 28. Recess 2750 is operable to receive a protrusion of primary fold gear 1202 of FIG. 28. Annular extension 2752 is operable to fit within the inner circumference of fold spring 2708.

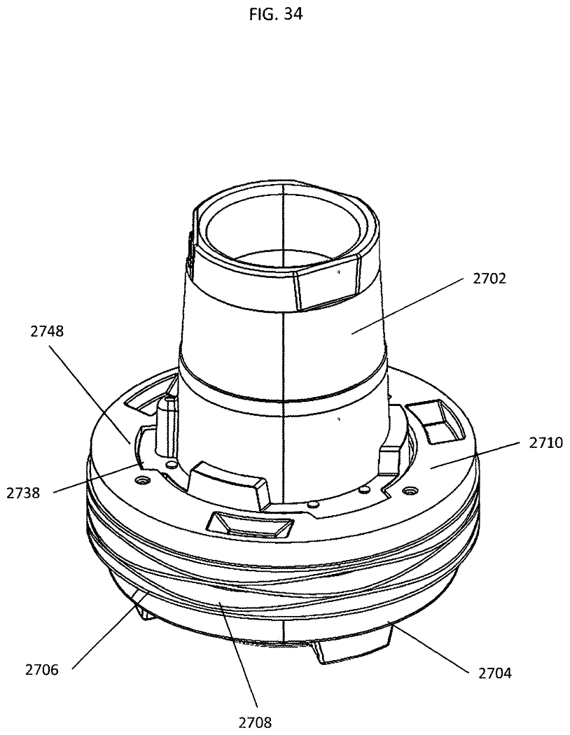

FIG. 34 illustrates fold clutch 2710 installed onto fold drive 506 in accordance with aspects of the present disclosure. However, it should be noted that for the sake of clarity, lower housing 404 is not shown in FIG. 34. As shown in the figure, fold clutch 2710 is lowered such that shaft 2702 passes through aperture 2746. Once protrusion 2738 of slip collar 2704 and recess 2748 of fold clutch 2710 are aligned, fold clutch 2710 can be lowered until it abuts fold spring 2708 and annular extension 2752 of fold clutch 2710 is arranged within the inner circumference of fold spring 2708.

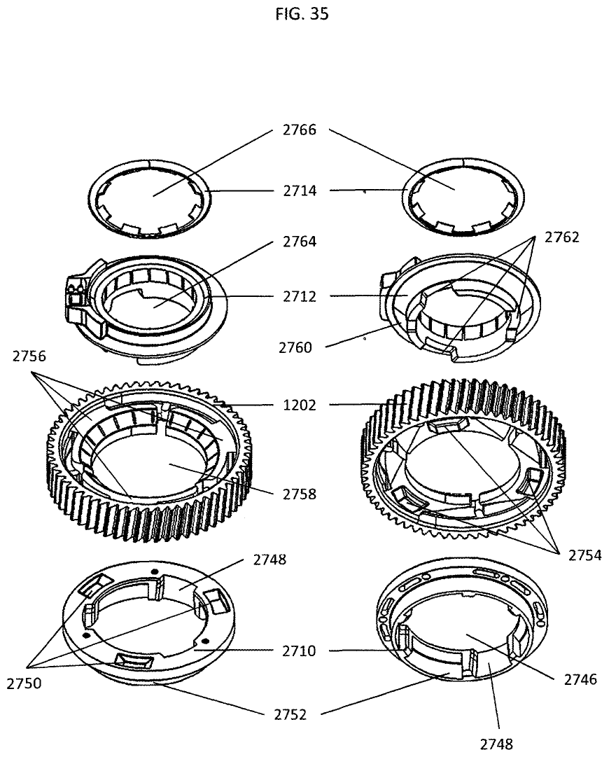

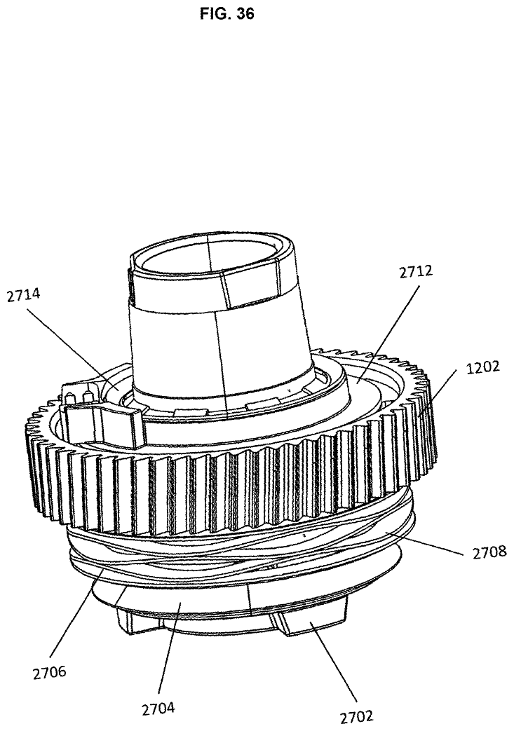

FIG. 35 illustrates a perspective view of fold clutch 2710, primary fold gear 1202, gear seat 2712, and retainer 2714 in accordance with aspects of the present disclosure. The left side of FIG. 35 illustrates a perspective view from the top-down and the right side of FIG. 35 illustrates a perspective view from the bottom-up. FIG. 36 illustrates fold drive 506 fully assembled in accordance with aspects of the present disclosure. However, it should be noted that for the sake of clarity, lower housing 404 is not shown.

As shown in FIGS. 35-36, fold clutch 2710 includes the elements described above in FIG. 33 and for purposes of brevity, will not be described again here. The figures additionally includes primary fold gear 1202, gear seat 2712, and retainer 2714. Protrusion 2754 of primary fold gear 1202 is operable to be received by recess 2750 of fold clutch 2710. When assembled within fold drive 506, protrusion 2754 of primary fold gear 1202 fits within recess 2750 of fold clutch 2710. In this manner, fold clutch 2710 and primary fold gear 1202 can be held in abutment against each other by the biasing force of fold spring 2708 in order to rotationally lock fold clutch 2710 and primary fold gear 1202.

The geometry of extension 2756 incorporates a taper which corresponds to taper 2760 of gear seat 2712. When assembled within fold drive 506, fold spring 2708 exerts a biasing force against fold clutch 2710 which is transferred to primary fold gear 1202, which forces the taper of extension 2756 against taper 2760 of gear seat 2712. The corresponding tapers of annular extension 2752 and gear seat 2712 ensures the correct alignment between primary fold gear 1202 and gear seat 2712. When assembled within fold drive 506, retainer 2714 is fixed in place along shaft 2702 to prevent movement of gear seat 2712, primary fold gear 1202, and fold clutch 2710 due to the biasing force of fold spring 2708.

Retainer 2714 is operable to be attached to shaft 2702 (not shown) and fixed in place such that it abuts gear seat 2712. Once fixed to shaft 2702, retainer 2714 can prevent movement of gear seat 2712, primary fold gear 1202, and fold clutch 2710.

Once shaft 2702, slip collar 2704, lower housing 404, lock ring 2706, fold spring 2708, and fold clutch 2710 have been assembled as described above in FIGS. 29-34, primary fold gear 1202 may be installed on shaft 2702.

Primary fold gear 1202 is lowered onto fold clutch 2710 such that shaft 2702 passes through aperture 2758 and protrusion 2754 of primary fold gear 1202 are received within recess 2750 of fold clutch 2710. Next, gear seat 2712 is lowered onto primary fold gear 1202 such that shaft 2702 passes through aperture 2764 until taper 2760 abuts the corresponding taper of extension 2756 of primary fold gear 1202. Finally, retainer 2714 is placed so that shaft 2702 passes through aperture 2766 and lowered until it abuts gear seat 2712, where it is then fixed in place. The fixing of retainer 2714 prevents movement of fold clutch 2710, primary fold gear 1202, and gear seat 2712 against the biasing force of fold spring 2708.

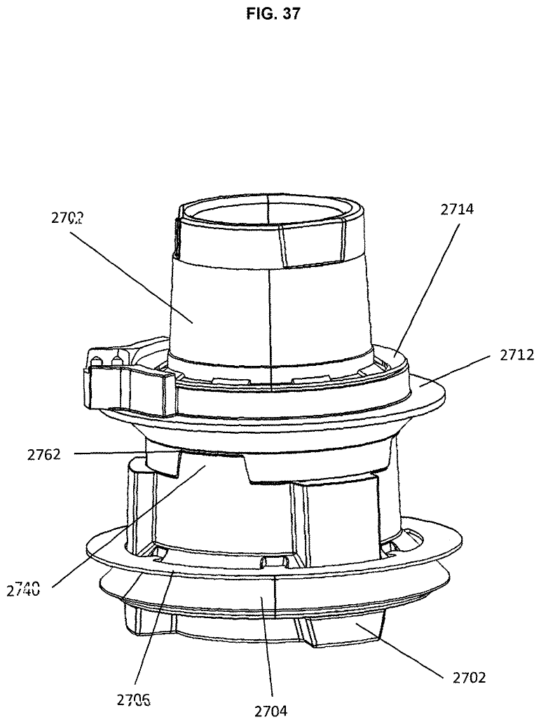

FIG. 37 illustrates an additional view for fold drive 506 assembled in accordance with aspects of the present disclosure. However, it should be noted that fold clutch 2710, primary fold gear 1202, fold spring 2708, and lower housing 404 have been removed for clarity.

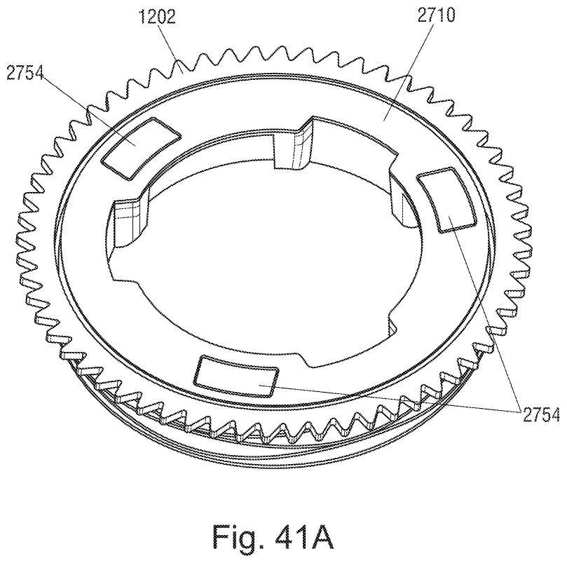

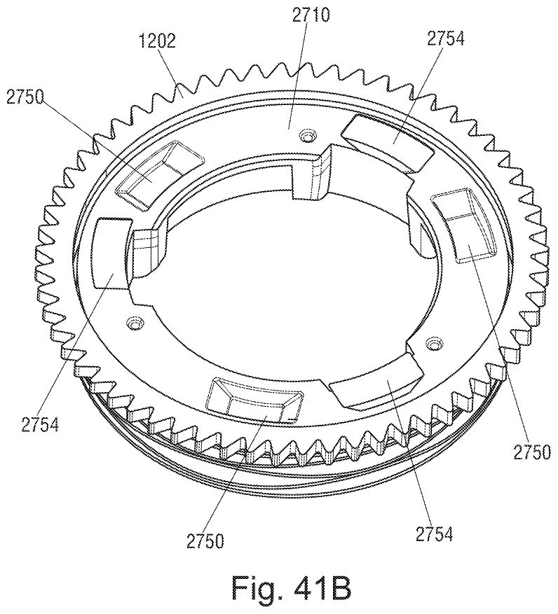

As shown in the figure, when fold drive 506 is assembled, gear seat 2712 abuts slip collar 2704 such that extension 2740 of slip collar 2704 is received by recess 2762 of gear seat 2712. Since slip collar 2704 is fixed in place by a force interference fit with shaft 2702 and gear seat 2712 is fixed in place by retainer 2714, it is possible to disengage fold clutch 2710 during manual operation of fold drive 506. Manual operation of fold drive 506 will be described later with reference to FIGS. 41A-B.

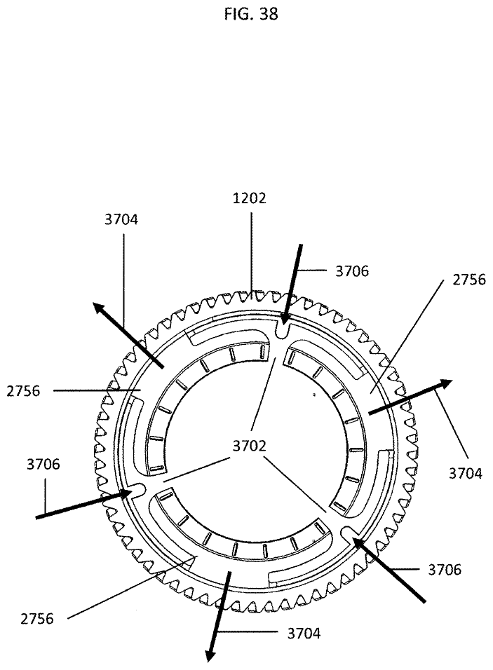

FIG. 38 illustrates a top-down view of primary fold gear 1202 in accordance with aspects of the present disclosure. In operation, when fold drive 506 is assembled within actuator 400 fold spring 2708 exerts a force against fold clutch 2710 which is then transferred to primary fold gear 1202. Primary fold gear 1202 is held in place against the force exerted by fold spring 2708 by retainer 2714 and gear seat 2712. In this arrangement, gear seat 2712 provides a counter force to fold spring 2708 which forces taper 2760 of gear seat 2712 against the taper of extension 2756. Primary fold gear 1202 is constrained to prevent movement along the direction of the force applied by fold spring 2708 which redirects the force radially outward due to the abutment of the tapers incorporated into gear seat 2712 and primary fold gear 1202.

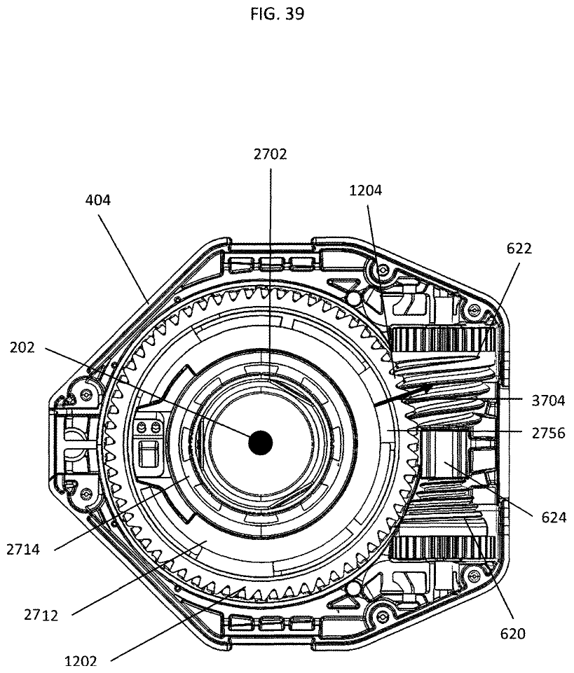

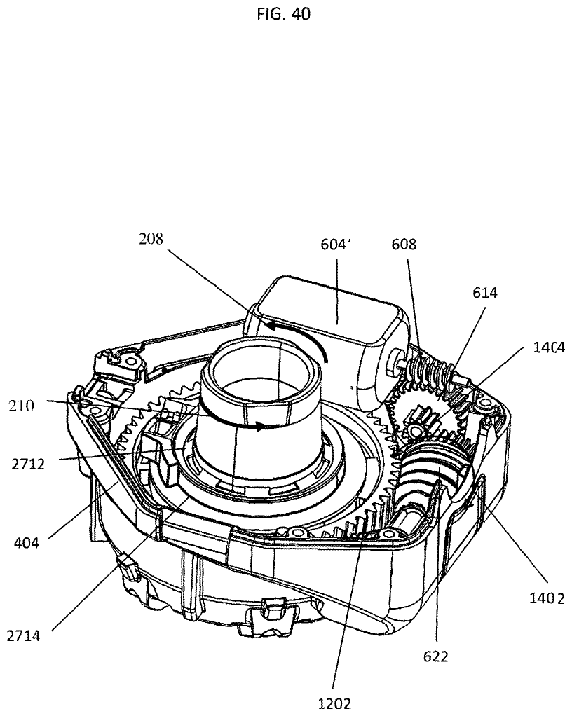

As shown in the figure, extension 2756 is distributed equidistant around the inner circumference of primary fold gear 1202 wherein each end of extension 2756 creates a gap 3702. The abutment of the taper of extension 2756 against taper 2560 of gear seat 2712 forces primary fold gear 1202 to expand radially along extension 2756 as shown by direction 3704. The expansion along direction 3704 is compensated for by gap 3702 which allows primary fold gear 1202 to contract inwards as shown by direction 3706. The expansion of primary fold gear 1202 along direction 3704 and contraction along direction 3706 creates a trilobal shape. The trilobal shape of primary fold gear 1202 improves the meshing with gear assembly 502, which will now be further described with reference to FIG. 39-40.

FIG. 39 illustrates a top-down view of fold drive 506 and gear sub assembly 616 installed within lower housing 404 in accordance with aspects of the present disclosure. FIG. 40 illustrates a perspective view of gear assembly 502 and fold drive 506 installed within lower housing 404 in accordance with aspects of the present disclosure. However, for purposes of clarity, all other elements of gear assembly 502 not utilized for the operation of fold drive 506 in FIGS. 39-40 have been removed. Additionally, in FIG. 39-40, lower housing 404 is shown at its nominal position.

As shown in FIGS. 39-40, when installed within lower housing 404, primary fold gear 1202 meshes with secondary fold gear 622 at point 1204. The arrangement of primary fold gear 1202 is chosen during assembly such that extension 2756 is located adjacent to secondary fold gear 622 of gear assembly 502. As described above in FIG. 38, primary fold gear 1202 has a trilobal form and expands along direction 3704 which increases the meshing between primary fold gear 1202 and secondary fold gear 622. The expansion of primary fold gear 1202 is such that it has a trilobal geometry and the improved meshing is at a maximum when mirror head 206 (not shown) is in a nominal position, since extension 2756 is adjacent to secondary fold gear 622 along direction 3704.

The improved meshing reduces backlash between primary fold gear 1202 and secondary fold gear 622. If a conventional cylindrical fold gear was used, small variations in the arrangement of components within fold drive 506 and even further, actuator 400, would result in free play between the gear teeth of primary fold gear 1202 and secondary fold gear 622. When not being operated, the free play between primary fold gear 1202 and secondary fold gear 622 would result in free play of mirror head 206 (not shown). The free play of mirror head 206 would introduce issues such as mirror head 206 vibrating or wobbling due to external forces such as wind while driving. Additionally, when fold drive 506 is electrically operated, the free play between the gear teeth of primary fold gear 1202 and secondary fold gear 622 would be closed as secondary fold gear 622 rotated. Once the space between the teeth of primary fold gear 1202 and secondary fold gear 622 is closed, the teeth would abruptly contact each other, which could damage either of primary fold gear 1202 or secondary fold gear 622 with repeated use.

In this example, primary fold gear 1202 has expanded to take a trilobal shape, however the primary fold gear 1202 may expand to other geometries as well. For example, if secondary fold gear 622 was too close to primary fold gear 1202, primary fold gear 1202 would deform such that extension 2756 nearest to secondary fold gear 622 would deform so that it moved in the opposing direction, which in this example would be opposite of direction 3704. The remaining extension 2756 would then deform to compensate for the deformation of extension 2756 adjacent to secondary fold gear 622. In this manner, primary fold gear 1202 can morph such that it has the optimal geometry to improve meshing between primary fold gear 1202 and secondary fold gear 622 to account for variations incurred in the production and mounting of the elements of actuator 400.

To operate fold drive 506, power is delivered to motor 604 from an external source (not shown), such as a vehicle's battery or electrical system, in particular via the circuitry 320. Once supplied with power, motor 604, in particular representing first drive device 330 will turn worm gear 608 (FIG. 6), which may then rotate intermediate fold gear 614, which in turn rotates secondary fold gear 622. Referring briefly to FIG. 34-35, since protrusion 2738 of slip collar 2704 is received within recess 2748 of fold clutch 2710, fold clutch 2710 is rotationally locked. With fold clutch 2710 rotationally locked and protrusion 2754 of primary fold gear 1202 received within recess 2750 of fold clutch 2710, primary fold gear 1202 is also rotationally locked.

Returning to FIG. 39-40, as secondary fold gear 622 rotates it results in lower housing 404, and by extension actuator 400, to rotate around primary fold gear 1202 centered about axis 202. Rotation of actuator 400 about primary fold gear 1202 occurs because shaft 2702 is fixed to mirror base 204 via aperture 2719 as described above in FIG. 29. Therefore, since shaft 2702 is static, so are each of slip collar 2704, lock ring 2706, and gear seat 2712. With these elements rotationally locked, when fold clutch 2710 is engaged, fold clutch 2710 and primary fold gear 1202 are rotationally locked as well. With shaft 2702, slip collar 2704, fold clutch 2710, primary fold gear 1202, and gear seat 2712 each rotationally locked while fold clutch 2710 is engaged, actuator 400 will rotate around axis 202 as secondary fold gear 622 rotates. In this example variation, when secondary fold gear 622 rotates in first fold gear direction 1402, actuator 400 rotates in first fold direction 208 and secondary fold gear 622 rotating in second fold gear direction 1404 results in actuator 400 rotating in second fold direction 210. The rotation of actuator 400 about primary fold gear 1202 occurs due to shaft 2702 being static.

As described above in FIG. 23, mirror head 206 is attached to actuator 400 via attachment point 1516 of tilt axle 1504. Therefore, when fold drive 506 is electrically operated, mirror head 206 will rotate about axis 202 in either first fold direction 208 or second fold direction 210. Operation of fold drive 506 in either first fold direction 208 or second fold direction 210 can be performed for short periods of time in order to adjust mirror head 206 such that an attached reflective element (not shown) provides an acceptable view rearward of the vehicle.

However, operation of fold drive 506 can be performed for longer periods of time in order to adjust mirror head 206 along first fold direction 208 from a drive position as shown in FIG. 2A to a stored position as shown in FIG. 2B. Alternatively, the operation of fold drive 506 can be performed for a longer period of time in order to adjust mirror head 206 along second fold direction 210 from a storage position as shown in FIG. 2B to a drive position as shown in FIG. 2A. The operation of fold drive 506 during manual operation will now be described with additional reference to FIGS. 41A-B.

FIG. 41A illustrates fold clutch 2710 engaged during manual operation of fold drive 506 in accordance with aspects of the present disclosure. FIG. 41B illustrates fold clutch 2710 disengaged during manual operation of fold drive 506 in accordance with aspects of the present disclosure.

When mirror head 206 is in the drive position, actuator 400 is in its nominal position as well. In the nominal position, fold clutch 2710 is engaged, meaning that protrusion 2754 of primary fold gear 1202 is located within recess 2750 of fold clutch 2710, as shown in FIG. 41A. During manual operation, mirror head 206 will rotate as it is manually adjusted which results in the rotation of actuator 400 since mirror head 206 is connected to actuator 400 via attachment point 1516 of tilt axle 1504.

As actuator 400 rotates, so does gear assembly 502, including secondary fold gear 622. Since secondary fold gear 622 meshes with primary fold gear 1202, as actuator 400 rotates the primary fold gear 1202 rotates. Referring briefly to FIG. 34, protrusion 2738 of slip collar 2704 is received by recess 2748, which rotationally locks fold clutch 2710. When primary fold gear 1202 is forced to rotate the edge of protrusion 2754 of primary fold gear 1202 slides against the edge of recess 2750 of fold clutch 2710. With primary fold gear 1202 biased towards gear seat 2712 which is fixed in place retainer 2714, fold clutch 2710 is displaced away from primary fold gear 1202, compressing fold spring 2708.

Referring to FIG. 41B, once the edge of protrusion 2754 of primary fold gear 1202 slides against the edge of recess 2750 of fold clutch 2710, fold clutch 2710 is forced towards fold spring 2708 and becomes disengaged from primary fold gear 1202. At this time, protrusion 2754 of primary fold gear 1202 is able to slide along the surface of fold clutch 2710. In this manner, the manual operation of fold drive 506 can be achieved while protecting gear assembly 502 and fold drive 506.

Returning mirror head 206 to its drive position can be achieved through electrical actuator or manual operation. In the case of manual operation, mirror head 206 can be rotated back towards its drive position. As mirror head 206 rotates, so does primary fold gear 1202 and protrusion 2754 slides along the surface of fold clutch 2710. As mirror head 206 approaches the drive position, protrusion 2754 of primary fold gear 1202 will begin to align with recess 2750 of fold clutch 2710. Once mirror head 206 reaches the drive position, the biasing force of fold spring 2708 will force protrusion 2754 of primary fold gear 1202 into recess 2750 of fold clutch 2710 such that fold clutch 2710 abuts primary fold gear 1202. At this time, fold clutch 2710 is engaged as described above in FIG. 41A.

In the case of electrical operation, power is delivered to motor 604 resulting in the rotation of secondary fold gear 622 as described above in FIGS. 39-40. Since fold clutch 2710 is disengaged, primary fold gear 1202 is free to rotate when driven instead of actuator 400 rotating around primary fold gear 1202. As primary fold gear 1202 rotates, protrusion 2754 of primary fold gear 1202 will begin to align with recess 2750 of fold clutch 2710. Once primary fold gear 1202 is rotated such that protrusion 2754 of primary fold gear 1202 aligns with recess 2750 of fold clutch 2710, the biasing force of fold spring 2708 will force fold clutch 2710 to abut primary fold gear 1202. At this time, fold clutch 2710 is engaged and fold drive 506 can be operated as described above in FIGS. 39-40 in order to actuate mirror head 206 back to the desired position.

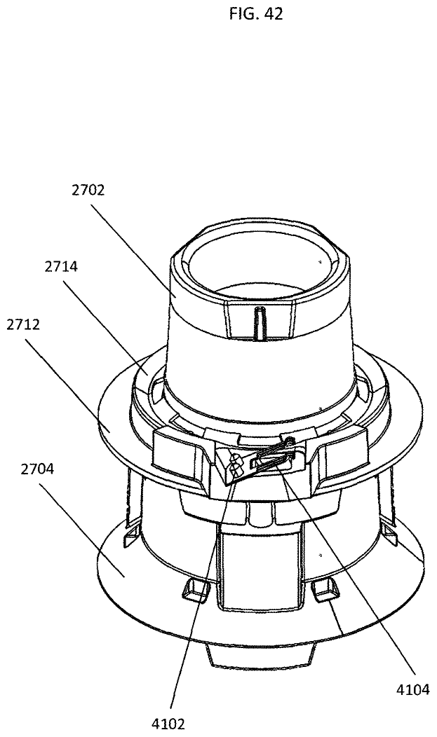

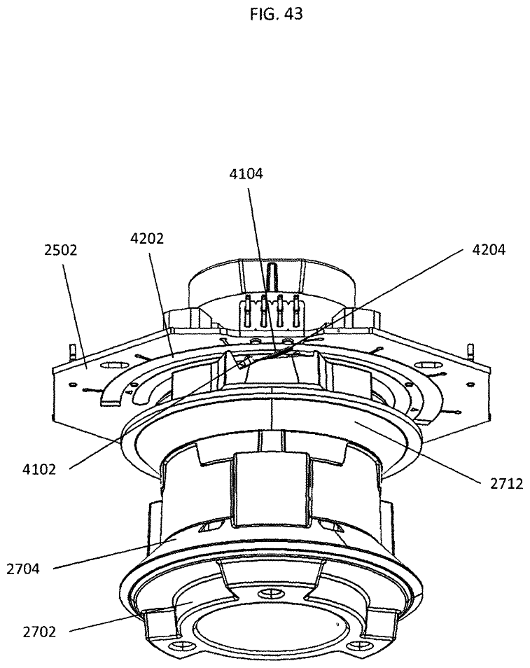

In some instances, it may be desirable to have a memory function for use with actuator 400. A memory function would allow the driver of a vehicle to set a specific fold and tilt angle for mirror head 206 that can then be stored at a later time. If the position of mirror head 206 is changed, the stored position could then be retrieved at a later time to automatically move mirror head 206 back to the stored position without any fine tune adjustment by the driver. A fold memory function of actuator 400 will now be described with reference to FIGS. 42-43.

FIG. 42 illustrates a fold memory wiper installed on gear seat 2712 in accordance with aspects of the present disclosure. As shown in the figure, gear seat 2712 includes a fold wiper carrier 4102 and a fold wiper 4104. Fold wiper 4104 is attached to gear seat 2712 via fold wiper carrier 4102. In this arrangement fold wiper 4104 remains static during the operation of actuator 400 since shaft 2702 is fixed to mirror base 204 via aperture 2719 as described above in FIG. 28. Therefore, since shaft 2702 is static, slip collar 2704, lock ring 2706, and gear seat 2712 which includes fold wiper carrier 4102 and fold wiper 4104 are also static.

FIG. 43 illustrates the operation of fold wiper 4104 in accordance with aspects of the present disclosure. As shown in the figure, PCB 2502 is arranged in its installed location within actuator 400 relative to fold drive 506. In this position, fold wiper 4104 contacts carbon strip 4202 of PCB 2502 at contact point 4204. PCB 2502 is arranged on upper housing 402 as described above in FIGS. 26-27, however for sake of clarity, upper housing 402 is not shown in FIG. 42-43.

As described above, during the operation of fold drive 506 shaft 2702, slip collar 2704, and gear seat 2712 will remain static while actuator 400 rotates about axis 202, including PCB 2502. As PCB 2502 rotates around axis 202 during the operation of fold drive 506, fold wiper 4104 will contact different points along carbon strip 4202. Once the desired fold position of mirror head 206 has been reached a measurement may be taken by a potentiometer (not shown) to record the position of fold wiper 4104 along carbon strip 4202. In order to adjust the fold angle of mirror head 206 by using the memory system, power may delivered to motor 602 to adjust the fold angle of mirror head 206 until the potentiometer system detects that the position of fold wiper 4104 has contacted the point along carbon strip 4202 that matches the stored position of fold wiper 4104 along carbon strip 4202.

Further advantageous embodiments of the disclosed subject matter are described with the help of the following clauses.

CLAUSE 1. Method for moving at least one rearview device of at least one rearview assembly around at least one first axis and around at least one second axis, by at least one actuator comprising at least one electrically driven first drive device and at least one electrically driven second drive device, characterized in that the method comprises controlling the first drive device and the second drive device such that only one of the drive devices is driven at a time.

CLAUSE 2. Method according to clause 1, wherein the method comprises providing at least one circuitry connected at least indirectly to the first drive device and the second drive device for controlling the first drive device and the second drive device.

CLAUSE 3. Method according to clause 2, wherein
by the circuitry, in particular with the help of at least one first power source, a power supply is switched between the first drive device and the second drive device and/or by the circuitry the chosen drive device is provided with energy of at least one second power source to move the rearview device.

CLAUSE 4. Method according to clause 3, wherein
the first power source provides the circuitry with a smaller maximum electrical output than the second power source.

CLAUSE 5. Method according to clause 3 or 4, wherein
in a first status of a first switch the first power source is coupled to a first subsection of the circuitry connected to the first drive device with a first polarity and to a second subsection of the circuitry connected to the second drive device with a second polarity and in a second status of the first switch the first power source is connected with the second polarity to the first subsection and with the first polarity to the second subsection.

CLAUSE 6. Method according to clause 5, wherein
at least one electronic element, in particular at least one diode, located in the first subsection or the second subsection is driven in a blocking direction when the respective subsection is connected with the first polarity to the first power source and is driven in a pass direction when the respective subsection is connected with the second polarity to the first power source.

CLAUSE 7. Method according to one of the clauses 3 to 6, wherein
in a first status of a second switch the second power source is coupled to the first subsection connected to the first drive device with a first polarity and to the second subsection connected to the second drive device with a second polarity and in a second status of the second switch the second power source is coupled to the first subsection with the second polarity and to the second subsection with the first polarity.

CLAUSE 8. Method according to one of the clauses 5 to 7, wherein
(i) in the first status of the first switch and the first status of the second switch the first drive device is driven in a first direction and/or in the first status of the first switch and the second status of the second switch the first drive device is driven in a, preferably with respect to the first direction opposite, second direction, wherein especially the second drive is not driven in the first status of the first switch and/or
(ii) in the second status of the first switch and the first status of the second switch the second drive device is driven in a third direction and/or in the second status of the first switch and the second status of the second switch the second drive device is driven in a, preferably with respect to the third direction opposite, fourth direction, wherein especially the first drive is not driven in the second status of the first switch.

CLAUSE 9. Method according to clause 8, wherein
the first direction of the first drive device corresponds to a movement of the rearview device around the first axis in a first direction, the second direction of the first drive device corresponds to a movement of the rearview device around the first axis in a second direction, the first direction of the second drive device corresponds to a movement of the rearview device around the second axis in a third direction and the fourth direction of the second drive device corresponds to a movement of the rearview device around the second axis in a fourth direction and/or the first axis corresponds to a tilt axis of the rearview device and/or the second axis corresponds to a fold axis of the rearview device.

CLAUSE 10. Actuator for moving at least one rearview device around at least one first axis and around at least one second axis, the actuator comprising at least one electrically driven first drive device and at least one electrically driven second drive device, characterized in that the actuator is configured to move the rearview device according to a method of one of the preceding clauses.

CLAUSE 11. Actuator according to clause 10, wherein
the actuator comprises at least one circuitry connected at least indirectly to the first drive device and the second drive device for controlling the first drive device and the second drive device.

CLAUSE 12. Actuator according to clause 11, wherein
the circuitry is connected to at least one first power source and/or at least one second power source.

CLAUSE 13. Actuator according to clause 11 or 12, wherein
the circuitry comprises at least one first switch to connect a first power supply to the first drive device and the second drive device.

CLAUSE 14. Actuator according to clause 13, wherein
the circuitry comprises at least one first subsection connected to the first drive device and at least one second subsection connected to the second drive device, wherein in at least one first status of the first switch the first power source is coupled to the first subsection with a first polarity and to the second subsection with a second polarity and in at least one second status with the second polarity to the first subsection and with the first polarity to the second subsection.

CLAUSE 15. Actuator according to clause 13 or 14, wherein
the circuitry, in particular the first subsection and/or the second subsection, comprises at least one electronic element, in particular at least one diode, wherein the electronic element is driven in a blocking direction when the respective subsection is connected with the first polarity to the first power source and is driven in a pass direction when the respective subsection is connected with the second polarity to the first power source.

CLAUSE 16. Actuator according to one of the clauses 11 to 15, wherein
the circuitry comprises at least one second switch, wherein in a first status of the second switch the second power source is coupled to the first subsection with a first polarity and to the second subsection with a second polarity and in a second status of the second switch the second power source is coupled to the first subsection with the second polarity and to the second subsection with the first polarity.

CLAUSE 17. Actuator according to clause 16, wherein
(i) in the first status of the first switch and the first status of the second switch the first drive device is driven in a first direction and/or in the first status of the first switch and the second status of the second switch the first drive device is driven in a, preferably with respect to the first direction opposite, second direction, wherein especially the second drive device is not driven in the first status of the first switch and/or
(ii) in the second status of the first switch and the first status of the second switch the second drive device is driven in a third direction and/or in the second status of the first switch and the second status of the second switch the second drive device is driven in a, preferably with respect to the third direction opposite, fourth direction, wherein especially the first drive device is not driven in the second status of the first switch.

CLAUSE 18. Actuator according to one of the clauses 10 to 17, wherein the first axis and the second axis are running at angle to each other, in particular the first axis and the second axis are running perpendicular to each other.

CLAUSE 19. Actuator according to one of the clauses 10 to 18, wherein the first drive device and/or the second drive device comprise at least one DC motor.

CLAUSE 20. Actuator according to one of the clauses 10 to 19, wherein
the actuator comprises at least one gear assembly having a secondary tilt gear and a secondary fold gear;
wherein said secondary tilt gear comprises a first spur gear portion, a first worm gear portion, and a first transition point, wherein said first transition point divides said secondary tilt gear into said first spur gear portion and said first worm gear portion;
wherein said first worm gear portion comprises a first end having a first diameter and a second end having a second diameter, wherein said first end is disposed adjacent to said first transition point of said secondary tilt gear and, wherein said second end is disposed opposite of said first end, and wherein said first diameter is larger than said second diameter;
wherein said secondary fold gear comprises a second spur gear portion, a second worm gear portion, and a second transition point, wherein said second transition point divides said secondary fold gear into said second spur gear portion and said second worm gear portion;
wherein said second worm gear portion comprises a third end having a third diameter and a fourth end having a fourth diameter, wherein said third end is disposed adjacent to said second transition point of said secondary fold gear and, wherein said fourth end is disposed opposite of said third end, and wherein said third diameter is larger than said fourth diameter; and wherein said second worm gear portion and said second spur gear portion are formed as a single element.

CLAUSE 21. Actuator according to one of the clauses 10, wherein said secondary fold gear comprises a cavity.

CLAUSE 22. Actuator according to clause 21, wherein
the gear assembly further comprises a biasing element and a worm insert, wherein the biasing element is received into said cavity of said secondary fold gear such that said worm insert is movably received in said cavity and abutted against said biasing element.

CLAUSE 23. Actuator according to one of the clauses 10 to 19, wherein
the actuator comprises at least one gear assembly having:
a secondary tilt gear comprising an aperture;
a secondary fold gear comprising an aperture and a cavity;
a spindle having a first end and a second end;
a biasing element;
a worm insert;
a slide having a channel;
wherein said aperture of said secondary tilt gear receives said first end of said spindle;
wherein said slide is attached to said spindle by fitting said channel onto said spindle, and wherein said slide is arranged adjacent to said secondary tilt gear;
wherein said biasing element is arranged to be received inside of said cavity of said secondary fold gear;
wherein said worm insert is arranged to be received inside of said cavity of said secondary fold gear;
wherein said biasing element is received into said cavity of said secondary fold gear such that said worm insert is movably received in said cavity and abutted against said biasing element; and
wherein said aperture of said secondary fold gear receives said second end of said spindle.

CLAUSE 24. Actuator according to clause 23, wherein
said biasing element exerts a biasing force against said worm insert; and wherein said biasing force biases said slide towards said secondary tilt gear.

CLAUSE 25. Actuator according to clause 23 or 24,
wherein said secondary tilt gear further comprises a first spur gear portion, a first worm gear portion, and a first transition point, wherein said first transition point divides said secondary tilt gear into said first spur gear portion and said first worm gear portion;
wherein said first worm gear portion comprises a first end having a first diameter and a second end having a second diameter, wherein said first end is disposed adjacent to said first transition point of said secondary tilt gear and, wherein said second end is disposed opposite of said first end, and wherein said first diameter is larger than said second diameter;
wherein said secondary fold gear further comprises a second spur gear portion, a second worm gear portion, and a second transition point, wherein said second transition point divides said secondary fold gear into said second spur gear portion and said second worm gear portion; wherein said second worm gear portion comprises a third end having a third diameter and a fourth end having a fourth diameter, wherein said third end is disposed adjacent to said second transition point of said secondary fold gear and, wherein said fourth end is disposed opposite of said third end, and wherein said third diameter is larger than said fourth diameter; and
wherein said second worm gear portion and said second spur gear portion are formed as a single element.

CLAUSE 26. Actuator according to one of the clauses 10 to 25, wherein
the rearview assembly has a rearview head and a rearview base, wherein preferably the rearview head comprises at least one mirror device and/or at least one camera device and/or the rearview head is moved relative to the mirror base by the actuator.

CLAUSE 27. Actuator according to one of the clauses 10 to 26, wherein
a fold drive comprises the first drive device, wherein preferably the fold drive is operable to rotate said rearview head in the first direction about the first axis relative to said rearview base and rotate said rearview head in the second direction about said first axis;
a tilt drive comprises the second drive device, wherein preferably the tilt drive is operable to rotate said rearview head in the third direction about the second axis relative to said rearview base and rotate said rearview head in the fourth direction about said second axis relative to said rearview base.

CLAUSE 28. Actuator according to one of the clauses 20 to 27, wherein
the rotation of said secondary fold gear in a first secondary fold gear direction results in said fold drive rotating said rearview head in said first direction about said first axis and wherein the rotation of said secondary fold gear in a second secondary fold gear direction results in said fold drive rotating said rearview head in said second direction about said first axis; and
wherein the rotation of said secondary tilt gear in a first secondary tilt gear direction results in said tilt drive rotating said rearview head in said third direction about said second axis and
wherein the rotation of said secondary tilt gear in a second secondary tilt gear direction results in said tilt drive rotating said rearview head in said fourth direction about said second axis.

CLAUSE 29. Actuator according to one of the clauses 20 to 28, wherein said secondary fold gear may rotate as said secondary tilt gear remains stationary.

CLAUSE 30. Actuator according to one of the clauses 20 to 29, wherein said secondary tilt gear may rotate as said secondary fold gear remains stationary.

CLAUSE 31. Actuator according to one of the clauses 20 to 30, wherein said secondary fold gear may rotate as said secondary tilt gear rotates.

CLAUSE 32. Actuator according to one of the clauses 10 to 19, wherein
said actuator comprises:
a primary fold gear; and
a secondary fold gear;
said primary fold gear comprising a plurality of extensions extending radially inward from an inner circumference of said primary fold gear; and a first set of teeth;
wherein a distance between each of said plurality of extensions is uniformly arranged around said inner circumference; and wherein said plurality of extensions further comprises a first taper;
said secondary fold gear having a second set of teeth; and
wherein said first set of teeth of said primary fold gear mesh with said second set of teeth of said secondary fold gear such that said first set of teeth and said second set of teeth have a first spacing.

CLAUSE 33. Actuator of clause 32, said actuator further comprising:
a gear seat arranged adjacent to said primary fold gear;
wherein said gear seat has a second taper; and
wherein said first taper of said primary fold gear contacts said second taper of said gear seat.

CLAUSE 34. Actuator of clause 33, further comprising
a spring operable to apply a biasing force to said primary fold gear such that said primary fold gear is biased towards said gear seat; and wherein a deformation of the primary fold gear occurs when said primary fold gear is biased towards said gear seat.

CLAUSE 35. Actuator of clause 34, wherein
said deformation of said primary fold gear modifies the first spacing between said first set of teeth of said primary fold gear and said second set of teeth of said secondary fold gear to a second spacing; wherein said first spacing is different than said second spacing.

CLAUSE 36. Actuator of one of the clauses 32 to 35, further comprises a secondary tilt gear comprising a spur gear portion, a worm gear portion, and a transition point;
wherein said transition point divides said secondary fold gear into said spur gear portion and said worm gear portion; and
wherein said worm gear portion comprises a second set of teeth.

CLAUSE 37. Actuator according to one of the clauses 10 to 19, wherein said actuator comprises:
a gear assembly comprising a primary tilt gear, a spindle and a carrier arranged on said spindle
wherein said carrier comprises a slot;
wherein said primary tilt gear comprises a carrier connector receivable in said slot of said carrier;
wherein said primary tilt gear may rotate in a first tilt direction or a second tilt direction; and
wherein said carrier is slidable in a first translation direction along said spindle when the primary tilt gear rotates in said first tilt direction; and said carrier is slidable in a second translation distance along the spindle when said primary tilt gear rotates in said second tilt direction.

CLAUSE 38. Actuator of clause 37, further comprising a wiper attached to said carrier.

CLAUSE 39. Actuator of clause 38, further comprising a PCB with an attached carbon strip wherein said wiper contacts said carbon strip.

CLAUSE 40. Actuator of clause 39, wherein said wiper is slidable along said carbon strip in a first wiper direction when said carrier slides in said first translation direction along said spindle; and
wherein said wiper is slidable along said carbon strip in a second wiper direction when said carrier slides in said second translation direction along said spindle.

CLAUSE 41. Actuator according to one of the clauses 10 to 40, wherein
the rearview device, in particular the rearview head, is movable around the first axis and/or the second axis, in particular in the first direction, the second direction, the third direction and/or the fourth direction, by at least 20 angular degrees, preferably by at least 25 angular degrees, more preferably by at least 40 angular degrees, more preferably by at least 60 angular degrees, most preferably by at least 90 angular degrees.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated.

### REFERENCE SIGN LIST

100—Vehicle
102—Exterior Rearview Mirror Assembly
104—Exterior Rearview Mirror Assembly
202—Axis
204—Mirror Base
206—Mirror Head
208—First Fold Direction
210—Second Fold Direction
302—Axis
304—First Tilt Direction
306—Second Tilt Direction
320—circuitry
322—first switch
324—second switch
326—first subsection
328—second subsection
330, 330′—first drive device
332, 332′—second drive device
336—diode
338—diode
340′—Door zone module
342′—Output
344′—Output
346′—Input
348′—Input
350′—first motor
352′—second motor
354′—drive device selection module
356′—direction selection module
358′—first drive device driver
360′—second drive device driver
362′ sensing device
364′ feedback line
400—Actuator
402—Upper Housing
404—Lower Housing
406—Fastener
408—Bearing
410—Bearing
412—End Surface
414—End Surface
416—Recess
418—Recess
420—Channel
422—Taper
502—Gear Assembly
504—Tilt Drive
506—Fold Drive
602—Motor
604—Motor
606—Worm Gear
608—Worm Gear
610—Intermediate Spindle
612—Intermediate Tilt Gear
614—Intermediate Fold Gear
616—Gear Sub Assembly
618—Spindle
620—Secondary Tilt Gear
622—Secondary Fold Gear
624—Slide
626—Worm Insert
628—Biasing Element
630—Channel
632—Aperture
634—Boss
636—End Surface
638—Cavity
640—Boss
642—End Surface
644—First End
646—Second End
648—Aperture
902—Spur Gear Portion
904—Worm Gear Portion
906—Transition Point
908—Diameter
910—Diameter
912—Spur Gear Portion
914—Worm Gear Portion
916—Transition Point
918—Diameter
920—Diameter
1202—Primary Fold Gear
1204—Point
1206—Point
1302—Primary Tilt Gear
1304—Tilt Gear Extension
1306—Point
1402—First Fold Gear Direction
1404—Second Fold Gear Direction
1406—First Tilt Gear Direction
1408—Second Tilt Gear Direction
1502—Tilt Journal
1504—Tilt Axle
1506—Tilt Clutch
1508—Tilt Spring
1510—Tilt Inner
1512—Aperture
1514—Taper
1516—Attachment Point
1518—Taper
1520—Taper
1522—Aperture
1524—Taper
1526—Aperture
1528—Protrusion
1530—Slot
1532—Recess
1534—Slot
1536—Extension
1538—Slot
1540—Protrusion
1542—Support
1544—Tilt Wiper Carrier Connector
2002—Aperture
2004—Bearing
2006—Recess
2008—Surface
2502—Printed Circuit Board (PCB)
2504—Tilt Wiper Carrier
2506—Slot
2508—Carbon Strip
2510—Tilt Wiper
2702—Shaft
2704—Slip Collar
2706—Lock Ring
2708—Fold Spring
2710—Fold Clutch
2712—Gear Seat
2714—Retainer
2716—Diameter
2718—Diameter
2720—Recess
2722—Pin
2724—Locator Pin
2726—Protrusion
2728—Recess
2730—Recess
2732—Taper
2734—Aperture
2736—Aperture
2738—Protrusion
2740—Extension
2742—Protrusion
2744—Aperture
2746—Aperture
2748—Recess
2750—Recess
2752—Annular Extension
2754—Protrusion
2756—Extension
2758—Aperture
2760—Taper
2762—Recess
2764—Aperture
2766—Aperture
3702—Gap
3704—Direction
5 3706—Direction
4102—Fold Wiper Carrier
4104—Fold Wiper
4202—Carbon Strip
4204—Contact Point

1. A method for moving at least one rearview device of at least one rearview assembly around at least one first axis and around at least one second axis, by at least one actuator comprising at least one electrically driven first drive device and at least one electrically driven second drive device, the method comprising:
controlling the first drive device and the second drive device such that only one of the drive devices is driven at a time; and
switching a power supply between the first drive device and the second drive device based on a first signal; and/or
switching the polarity provided to the first drive device and the second drive device based on a second signal, wherein the first signal is provided by at least one first power source and the second signal is provided by at least one second power source.

2. The method according to claim 1, wherein the method further comprises:
providing at least one circuitry connected at least indirectly to the first drive device and the second drive device for controlling the first drive device and the second drive device, wherein the circuitry is connectable to the actuator and/or the circuitry is at least partly comprised by the actuator.

3. (canceled)

4. The method according to claim 1, wherein the first signal is provided to a first input of the circuitry and the second signal is provided to a second input of the circuitry.

5. The method according to claim 1, wherein the first signal, provided to the first input, is at least partly formed by the output of the first power source with a first polarity to switch the power supply to the first drive device and/or the first signal, provided to the first input, is at least partly formed by the output of the first power source with a second polarity being opposite to the first polarity to switch the power supply to the second drive device.

6. The method according to claim 1, wherein the second signal, provided to the second input, is at least partly formed by the output of the second power source with a first polarity to run the first drive device in a first direction or the second drive device in a third direction and/or the second signal, provided to the second input, is at least partly formed by the output of the second power source with a second polarity being opposite to the first polarity to run the first drive device in a, in particular to the first direction opposite, second direction or to run the second drive device in a, in particular to the third direction opposite, fourth direction.

7. The method according to claim 2, wherein by the circuitry, with the help of at least one first power source, a power supply is switched between the first drive device and the second drive device and/or by the circuitry the chosen drive device is provided with energy of at least one second power source to move the rearview device.

8. The method according to claim 5, wherein the first power source provides the circuitry with a smaller maximum electrical output than the second power source.

9. The method according to claim 5, wherein the second power source provides the circuitry with a smaller maximum electrical output than the first power source.

10. The method according to claim 7, wherein in a first status of a first switch the first power source is coupled to a first subsection of the circuitry connected to the first drive device with a first polarity and to a second subsection of the circuitry connected to the second drive device with a second polarity and in a second status of the first switch the first power source is connected with the second polarity to the first subsection and with the first polarity to the second subsection.

11. The method according to claim 10, wherein at least one diode located in the first subsection or the second subsection is driven in a blocking direction when the respective subsection is connected with the first polarity to the first power source and is driven in a pass direction when the respective subsection is connected with the second polarity to the first power source.

12. The method according to claim 7, wherein in a first status of a second switch the second power source is coupled to the first subsection connected to the first drive device with a first polarity and to the second subsection connected to the second drive device with a second polarity and in a second status of the second switch the second power source is coupled to the first subsection with the second polarity and to the second subsection with the first polarity.

13. The method according to claim 10, wherein
(i) in the first status of the first switch and the first status of the second switch the first drive device is driven in a first direction and/or in the first status of the first switch and the second status of the second switch the first drive device is driven in a, with respect to the first direction opposite, second direction, wherein the second drive is not driven in the first status of the first switch and/or
(ii) in the second status of the first switch and the first status of the second switch the second drive device is driven in a third direction and/or in the second status of the first switch and the second status of the second switch the second drive device is driven in a, with respect to the third direction opposite, fourth direction, wherein the first drive is not driven in the second status of the first switch.

14. The method according to claim 6, wherein the first direction of the first drive device corresponds to a movement of the rearview device around the first axis in a first direction, the second direction of the first drive device corresponds to a movement of the rearview device around the first axis in a second direction, the first direction of the second drive device corresponds to a movement of the rearview device around the second axis in a third direction and the fourth direction of the second drive device corresponds to a movement of the rearview device around the second axis in a fourth direction and/or the first axis corresponds to a tilt axis of the rearview device and/or the second axis corresponds to a fold axis of the rearview device.

15. Circuitry connectable to at least one actuator for moving at least one rearview device around at least one first axis and around at least one second axis, the actuator comprising
at least one electrically driven first drive device; and
and at least one electrically driven second drive device,
wherein the circuitry is configured to
control the first drive device and the second drive device such that only one of the drive devices is driven at a time; and
switch a power supply between the first drive device and the second drive device based on a first signal; and/or
switch the polarity provided to the first drive device and the second drive device based on a second signal, wherein the first signal is provided by at least one first power source and the second signal is provided by at least one second power source,
wherein the circuitry comprises at least one first input, wherein at least one first signal can be provided to the first input and by the first signal a power supply is switched between the first drive device and the second drive device, and the circuitry comprises at least one second input, wherein at least one second signal can be provided to the second input and by the second signal the polarity provided to the first drive device and/or the second drive device is switched, and
wherein the first signal is provided by the first power source and the second signal is provided by at least one second power source.

16. The circuitry according to claim 15, wherein the circuitry is connected at least indirectly to the first drive device and the second drive device for controlling the first drive device and the second drive device.

17. The circuitry according to claim 16, wherein the circuitry is connected, at least indirectly, via at least one vehicle module to at least one first power source and/or at least one second power source.

18. (canceled)

19. The circuitry according to claim 15, 18, wherein the first signal is at least partly formed by the output of the first power source with a first polarity to switch the power supply to the first drive device and/or the first signal is at least partly formed by the output of the first power source with a second polarity being opposite to the first polarity to switch the power supply to the second drive device.

20. The circuitry according to claim 15, wherein the second signal is at least partly formed by the output of the second power source with a first polarity to run the first drive device in a first direction or the second drive device in a third direction and/or the second signal is at least partly formed by the output of the second power source with a second polarity being opposite to the first polarity to run the first drive device in a, in particular to the first direction opposite, second direction or to run the second drive device in a, in particular to the third direction opposite, fourth direction.

21. The circuitry according to claim 15, wherein the circuitry and/or the first drive device comprises at least one first drive device driver to control at least one actuator or motor of the first drive device and/or the circuitry and/or of the second drive device comprises at least one second drive device driver to control at least one actuator or motor of the second drive device.

22. The circuitry according to claim 15, wherein the circuitry comprises at least one first switch, at least partly comprised by the vehicle module, to connect a first power source to the first drive device and the second drive device.

23. The circuitry according to claim 22, wherein the circuitry comprises at least one first subsection connected to the first drive device and at least one second subsection connected to the second drive device, wherein in at least one first status of the first switch the first power source is coupled to the first subsection with a first polarity and to the second subsection with a second polarity and in at least one second status with the second polarity to the first subsection and with the first polarity to the second subsection.

24. The circuitry according to claim 22, wherein the first subsection and/or the second subsection comprises at least one electronic element, wherein the electronic element is driven in a blocking direction when the respective subsection is connected with the first polarity to the first power source and is driven in a pass direction when the respective subsection is connected with the second polarity to the first power source.

25. The circuitry according to claim 16, one of the claims 16 to 24, wherein the circuitry comprises at least one second switch, wherein in a first status of the second switch the second power source is coupled to the first subsection with a first polarity and to the second subsection with a second polarity and in a second status of the second switch the second power source is coupled to the first subsection with the second polarity and to the second subsection with the first polarity.

26. The circuitry according to claim 25, wherein
(i) in the first status of the first switch and the first status of the second switch the first drive device is driven in a first direction and/or in the first status of the first switch and the second status of the second switch the first drive device is driven in a, with respect to the first direction opposite, second direction, wherein the second drive device is not driven in the first status of the first switch and/or
(ii) in the second status of the first switch and the first status of the second switch the second drive device is driven in a third direction and/or in the second status of the first switch and the second status of the second switch the second drive device is driven in a, with respect to the third direction opposite, fourth direction, wherein the first drive device is not driven in the second status of the first switch.

27. An actuator for moving at least one rearview device around at least one first axis and around at least one second axis, the actuator comprising at least one electrically driven first drive device and at least one electrically driven second drive device, wherein the actuator is connectable or connected to and/or at least partly comprises a circuitry according to claim 15.

28. The actuator according to claim 27, wherein the first axis and the second axis are running at angle to each other, the first axis and the second axis are running perpendicular to each other and/or the first drive device and/or the second drive device comprise at least one DC motor.

29. The actuator according to claim 27, wherein the the circuitry comprises at least one sensing device, at least indirectly connected to the vehicle module, wherein by the sensing device at least one first parameter of the first drive device and/or at least one second parameter of the second drive device is determinable.

30. The actuator according to claim 29, wherein the first parameter and/or the second parameter comprises at least one position, at least one moving direction, at least one moving speed and/or at least one acceleration of the first drive device and/or the second drive device.

31. The actuator Actuator according to claim 27, wherein
the actuator comprises at least one gear assembly having a secondary tilt gear and a secondary fold gear;
wherein said secondary tilt gear comprises a first spur gear portion, a first worm gear portion, and a first transition point, wherein said first transition point divides said secondary tilt gear into said first spur gear portion and said first worm gear portion;
wherein said first worm gear portion comprises a first end having a first diameter and a second end having a second diameter, wherein said first end is disposed adjacent to said first transition point of said secondary tilt gear and, wherein said second end is disposed opposite of said first end, and wherein said first diameter is larger than said second diameter;
wherein said secondary fold gear comprises a second spur gear portion, a second worm gear portion, and a second transition point, wherein said second transition point divides said secondary fold gear into said second spur gear portion and said second worm gear portion;
wherein said second worm gear portion comprises a third end having a third diameter and a fourth end having a fourth diameter, wherein said third end is disposed adjacent to said second transition point of said secondary fold gear and, wherein said fourth end is disposed opposite of said third end, and wherein said third diameter is larger than said fourth diameter; and
wherein said second worm gear portion and said second spur gear portion are formed as a single element.

32. The actuator according to claim 27, wherein said secondary fold gear comprises a cavity.

33. The actuator according to claim 32, wherein the gear assembly further comprises a biasing element and a worm insert, wherein the biasing element is received into said cavity of said secondary fold gear such that said worm insert is movably received in said cavity and abutted against said biasing element.

34. The actuator according to claim 27, wherein
the actuator comprises at least one gear assembly comprising:
a secondary tilt gear comprising an aperture;
a secondary fold gear comprising an aperture and a cavity;
a spindle having a first end and a second end;
a biasing element;
a worm insert;
a slide having a channel;
wherein said aperture of said secondary tilt gear receives said first end of said spindle;
wherein said slide is attached to said spindle by fitting said channel onto said spindle, and wherein said slide is arranged adjacent to said secondary tilt gear;
wherein said biasing element is arranged to be received inside of said cavity of said secondary fold gear;
wherein said worm insert is arranged to be received inside of said cavity of said secondary fold gear;
wherein said biasing element is received into said cavity of said secondary fold gear such that said worm insert is movably received in said cavity and abutted against said biasing element; and
wherein said aperture of said secondary fold gear receives said second end of said spindle.

35. The actuator according to claim 34, wherein said biasing element exerts a biasing force against said worm insert, and wherein said biasing force biases said slide towards said secondary tilt gear.

36. The actuator according to claim 34,
wherein said secondary tilt gear further comprises a first spur gear portion, a first worm gear portion, and a first transition point, wherein said first transition point divides said secondary tilt gear into said first spur gear portion and said first worm gear portion;
wherein said first worm gear portion comprises a first end having a first diameter and a second end having a second diameter, wherein said first end is disposed adjacent to said first transition point of said secondary tilt gear and, wherein said second end is disposed opposite of said first end, and wherein said first diameter is larger than said second diameter;
wherein said secondary fold gear further comprises a second spur gear portion, a second worm gear portion, and a second transition point, wherein said second transition point divides said secondary fold gear into said second spur gear portion and said second worm gear portion;
wherein said second worm gear portion comprises a third end having a third diameter and a fourth end having a fourth diameter, wherein said third end is disposed adjacent to said second transition point of said secondary fold gear and, wherein said fourth end is disposed opposite of said third end, and wherein said third diameter is larger than said fourth diameter; and
wherein said second worm gear portion and said second spur gear portion are formed as a single element.

37. The actuator according claim 27, wherein the rearview assembly has a rearview head and a rearview base, wherein the rearview head comprises at least one mirror device and/or at least one camera device and/or the rearview head is moved relative to the mirror base by the actuator.

38. The actuator according to claim 27, wherein
a fold drive comprises the first drive device, wherein the fold drive is operable to rotate said rearview head in the first direction about the first axis relative to said rearview base and rotate said rearview head in the second direction about said first axis;
a tilt drive comprises the second drive device, wherein the tilt drive is operable to rotate said rearview head in the third direction about the second axis relative to said rearview base and rotate said rearview head in the fourth direction about said second axis relative to said rearview base.

39. The actuator according to claim 31, wherein
the rotation of said secondary fold gear in a first secondary fold gear direction results in said fold drive rotating said rearview head in said first direction about said first axis and wherein the rotation of said secondary fold gear in a second secondary fold gear direction results in said fold drive rotating said rearview head in said second direction about said first axis; and
wherein the rotation of said secondary tilt gear in a first secondary tilt gear direction results in said tilt drive rotating said rearview head in said third direction about said second axis and wherein the rotation of said secondary tilt gear in a second secondary tilt gear direction results in said tilt drive rotating said rearview head in said fourth direction about said second axis.

40. The actuator according to claim 31, wherein said secondary fold gear may rotate as said secondary tilt gear remains stationary.

41. The actuator according to claim 31, wherein said secondary tilt gear may rotate as said secondary fold gear remains stationary.

42. The actuator according to claim 31, wherein said secondary fold gear may rotate as said secondary tilt gear rotates.

43. The actuator according to claim 27, wherein
said actuator comprises:
a primary fold gear; and
a secondary fold gear;
said primary fold gear comprising a plurality of extensions extending radially inward from an inner circumference of said primary fold gear; and a first set of teeth;
wherein a distance between each of said plurality of extensions is uniformly arranged around said inner circumference; and wherein said plurality of extensions further comprises a first taper;
said secondary fold gear having a second set of teeth; and
wherein said first set of teeth of said primary fold gear mesh with said second set of teeth of said secondary fold gear such that said first set of teeth and said second set of teeth have a first spacing.

44. The actuator of claim 43, said actuator further comprising:
a gear seat arranged adjacent to said primary fold gear;
wherein said gear seat has a second taper; and
wherein said first taper of said primary fold gear contacts said second taper of said gear seat.

45. The actuator of claim 44, further comprising
a spring operable to apply a biasing force to said primary fold gear such that said primary fold gear is biased towards said gear seat; and wherein a deformation of the primary fold gear occurs when said primary fold gear is biased towards said gear seat.

46. The actuator of claim 45,
wherein said deformation of said primary fold gear modifies the first spacing between said first set of teeth of said primary fold gear and said second set of teeth of said secondary fold gear to a second spacing;
wherein said first spacing is different than said second spacing.

47. The actuator of claim 43, further comprising
a secondary tilt gear comprising a spur gear portion, a worm gear portion, and a transition point;
wherein said transition point divides said secondary fold gear into said spur gear portion and said worm gear portion; and
wherein said worm gear portion comprises a second set of teeth.

48. The actuator according to claim 27, wherein said actuator comprises:
a gear assembly comprising a primary tilt gear, a spindle and a carrier arranged on said spindle
wherein said carrier comprises a slot;
wherein said primary tilt gear comprises a carrier connector receivable in said slot of said carrier;
wherein said primary tilt gear may rotate in a first tilt direction or a second tilt direction; and
wherein said carrier is slidable in a first translation direction along said spindle when the primary tilt gear rotates in said first tilt direction, and said carrier is slidable in a second translation distance along the spindle when said primary tilt gear rotates in said second tilt direction.

49. The actuator of claim 48, further comprising a wiper attached to said carrier.

50. The actuator of claim 49, further comprising a PCB with an attached carbon strip wherein said wiper contacts said carbon strip.

51. The actuator of claim 50,
wherein said wiper is slidable along said carbon strip in a first wiper direction when said carrier slides in said first translation direction along said spindle; and
wherein said wiper is slidable along said carbon strip in a second wiper direction when said carrier slides in said second translation direction along said spindle.

52. The actuator according to claim 27, wherein the rearview head is movable around the first axis and/or the second axis, in the first direction, the second direction, the third direction and/or the fourth direction, by at least 20 angular degrees.
